(19) United States
(12) Patent Application Publication
(10) Pub. No.: US 2025/0368240 A1
(43) Pub. Date: Dec. 4, 2025

(54) PIPE-BASED DELIVERY NETWORK USING SELF-DIRECTED PODS

(71) Applicant: Pipedream Laboratories, Inc., Austin, TX (US)

(72) Inventors: Kyle Buchannan Reeves, Austin, TX (US); Thomas John Godden, Austin, TX (US); MacCallister Jordan Steele Higgins, Austin, TX (US); Mikhale James Johnson, Austin, TX (US); Austin Trevor Paynter, Austin, TX (US)

(73) Assignee: Pipedream Laboratories, Inc., Austin, TX (US)

(21) Appl. No.: 18/731,327

(22) Filed: Jun. 2, 2024

(51) Int. Cl. B61L 27/16; B61B 13/10; B61L 25/02; B61L 25/04; B61L 27/70; G06Q 10/0833

(52) U.S. Cl. CPC B61L 27/16; B61B 13/10; B61L 25/025; B61L 25/048; B61L 27/70; G06Q 10/0833; B61L 2205/00; B61L 2210/02

(57) ABSTRACT

A system and method for transit of delivery pods across a pipe network, including: a commodity-based pipe network configured to provide a transit for delivery pods; a portal configured to enable insertion and removal of removable totes from pods, the portal including a wireless navigation beacon configured to provide navigation data to pods as they traverse the pipe network within proximity of the portal; an active pod including: a cargo module carrying a removable tote including a payload, a wireless communication module configured to obtain a set of navigation data from the wireless navigation beacon as the active pod approaches a location of the portal; and a control module configured to: (i) record the set of navigation data along with a timestamp indicating a traversal time, and (ii) dynamically update an intended route through the pipe network based on the set of navigation data to generate a modified route.

### CROSS-REFERENCE TO RELATED APPLICATIONS

This application is related to, and herein incorporates by reference in their entirety and for all purposes, the following copending U.S. Patent Applications: (i) U.S. patent application Ser. No. ______, Attorney Docket pipe.00001.us.n.1, entitled “PIPE-BASED DELIVERY NETWORK USING SELF-DIRECTED PODS”, filed ______, including inventor Kyle Canon Reeves; (ii) U.S. patent application Ser. No. ______, Attorney Docket pipe.00003.us.n.1, entitled “PIPE-BASED DELIVERY NETWORK USING SELF-DIRECTED PODS”, filed, including inventor Kyle Canon Reeves; and (iii) U.S. patent application Ser. No. ______, Attorney Docket pipe.00004.us.n.1, entitled “PIPE-BASED DELIVERY NETWORK USING SELF-DIRECTED PODS”, filed, including inventor Kyle Canon Reeves.

### BACKGROUND

The most significant recent developments in supply chain and delivery have been in the areas of logistics software, routing algorithms, vertical integration, and economies of scale. These improvements have resulted in unparalleled efficiency. For example, same-day shipping of goods is now commonplace in most metropolitan areas of the United States. With the advent of peer-to-peer services such as Uber, and various other services marketplaces, the supply chain and delivery business has become largely commoditized. Never before has the cost, speed, and availability of goods and services been so advantageous to consumers and businesses in the capital economy.

Despite these advances, most goods and materials worldwide still travel by way of cargo freight container ships and trucks. With few exceptions such as last-mile delivery services, the actual means of transporting goods from one location to another remain largely unchanged. The abundance of cheap fossil fuels has historically lowered the incentives for developing newer, faster, cheaper, and more efficient means of transportation, though more recently, the societal and environmental impacts have become a growing concern.

Despite these challenges, the market for transportation is unimaginably large. Every part of the modern economy depends on the ability to transport goods from one place to another. Everything from raw materials and consumer goods to medical supplies and equipment depends upon this infrastructure. Overpopulation, congestion of roads and freeways, and the urbanization movement have not only increased the aggregate demand for goods, but have also made existing methods of conveyance less desirable or even entirely infeasible in certain situations.

### SUMMARY

In general, in one aspect, embodiments relate to a pipe delivery system. The system includes delivery pods configured to transport payloads across a pipe network. The pipe network includes an extensible infrastructure of portal locations, junctions, communication devices, and other components for storage, caching, logistics, and integration with a variety of internal and external systems.

In general, in one aspect, embodiments relate to a delivery system. The system can include: a commodity-based pipe network configured to provide a transit for delivery pods; a portal configured to enable insertion and removal of removable totes from pods, the portal including a wireless navigation beacon configured to provide navigation data to pods as they traverse the pipe network within proximity of the portal; an active pod including: a cargo module carrying a removable tote including a first payload, a wireless communication module configured to obtain a set of navigation data from the wireless navigation beacon as the active pod approaches a location of the portal, wherein the set of navigation data includes an identifier that may be utilized to identify the portal; and a control module configured to: (i) record the set of navigation data along with a timestamp indicating a traversal time, and (ii) dynamically update an intended route through the pipe network based on the set of navigation data to generate a modified route.

In general, in one aspect, embodiments relate to a delivery system. The system can include: a commodity-based pipe network configured to provide a transit for delivery pods; a distributed network of pods configured to deliver a plurality of payloads to and from one or more portal locations of the pipe network; a logistics server configured to: send departure and destination locations for each of the plurality of payloads to a portal hub application at a portal location of each payload, and receive route status information for each of the plurality of payloads from the distributed network of pods, communicate one or more change events to the distributed network of pods, wherein each of the distributed network of pods is configured to independently self-correct in response to the change event and, after self-correcting, transmit updated route information for the logistics server.

In general, in one aspect, embodiments relate to a method for delivery. The method can include: (i) inserting a self-powered pod including a delivery payload into a pipe network of a delivery system, (ii) determining an original route through the pipe network based on the payload and a network map of the pipe network, (iii) while traversing the pipe network along the original route, reading a plurality of passive navigation markers located in proximity to the pipe network at various locations, (iv) communicating, via a distributed network of one or more adjacent self-powered pods, status information including location checkpoints corresponding to the plurality of passive navigation markers to an external logistics server, (v) detecting a change event via the distributed network, (vi) modifying the original route to generate an updated route in response to the change event, and (vii) relaying, via the distributed network, the updated route to the external logistics server.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIGS. 1-6 show schematic diagrams of various pipe network topologies, in accordance with one or more embodiments.

FIGS. 7A, 7B, and 8 depict cross-sectional and isometric views of a guide rail, in accordance with one or more embodiments.

FIG. 9 shows a schematic diagram of a logistics server, in accordance with one or more embodiments.

FIGS. 10A-10E depict views of a turntable junction design, in accordance with one or more embodiments.

FIG. 11 depicts a design of a tote exchange system, in accordance with one or more embodiments.

FIG. 12 depicts a design of a gate assembly, in accordance with one or more embodiments.

FIG. 13 depicts a schematic diagram of a terminal hub, in accordance with one or more embodiments.

FIGS. 14A-14D depict isometric views of a portal, in accordance with one or more embodiments.

FIG. 15 depicts an isometric view of a tote lift mechanism, in accordance with one or more embodiments of the invention.

FIGS. 16A and 16B depict isometric cross-sectional views of a tote cache system, in accordance with one or more embodiments of the invention.

FIG. 17 depicts an isometric view of a tote exchange system, in accordance with one or more embodiments of the invention.

FIG. 18 depicts an isometric view of a drain basin, in accordance with one or more embodiments of the invention.

FIGS. 19-20 depict schematic diagrams of communication architectures, in accordance with one or more embodiments.

FIGS. 21A, 21B, and 22 depict example designs of a pod, in accordance with one or more embodiments of the invention.

FIGS. 23A-23D depict isometric views of a pod, a cargo module, and a drive unit, in accordance with one or more embodiments of the invention.

FIG. 24 depicts a cross-section of a pod within a pipe, in accordance with one or more embodiments of the invention.

FIG. 25 shows a flowchart in accordance with one or more embodiments.

FIGS. 26 and 27 show a computing system and network architecture in accordance with one or more embodiments.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

In general, embodiments of the present disclosure provide methods and systems for transit of delivery pods across a pipe network. The pipe network can include segments of pipe optionally residing substantially underground, with portal locations for insertion and removal of delivery pods from the network. Junction locations can optionally provide a mechanism for routing pods across the network according to a specified delivery location for their payload(s).

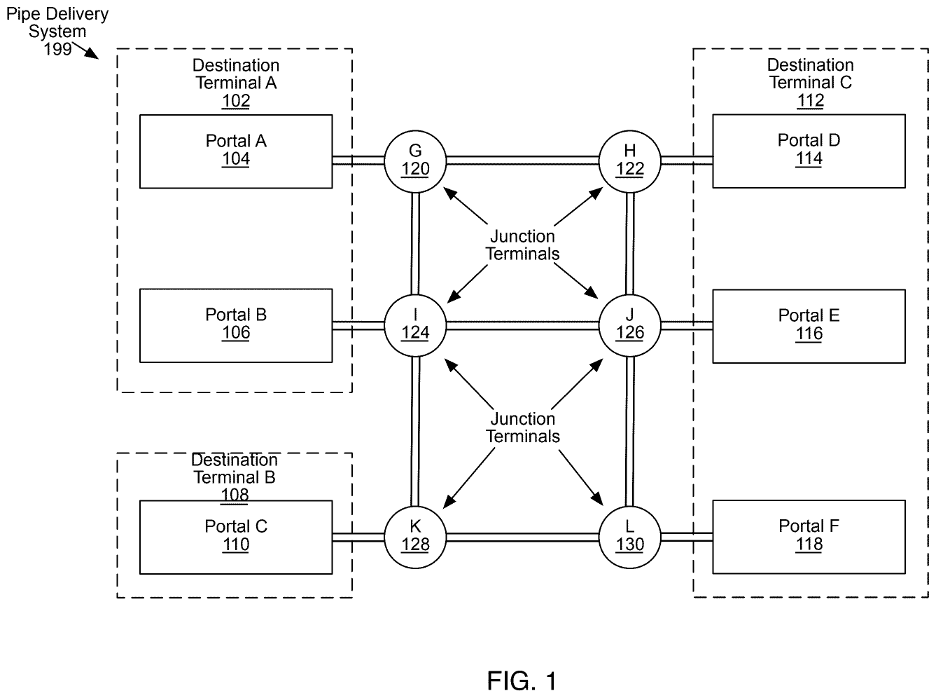

FIG. 1 shows an example of a pipe delivery system 199 enabling automated transportation of goods, in accordance with one or more embodiments. As shown in FIG. 1, the pipe delivery system 199 has multiple components including pipe segments, terminals (102, 108, 112), portals (104, 106, 110, 114, 116, 118), and junctions (120, 122, 124, 126, 128, 130). One or more components of the system 199 can optionally reside substantially or partially underground, or within a medium. Those skilled in the art will appreciate that the number and specific arrangement of the components can be customized to fit the specific geographic, functional, or other requirements of a given embodiment.

### Network Architecture

In one or more embodiments of the invention, the infrastructure of the pipe delivery system is designed to piggyback on existing utility structures, such as sewers, water, electrical, and gas utilities. This co-utilization of easements allows the pipe delivery system to be integrated into urban environments more seamlessly and cost-effectively. Terminal locations within this system may overlap with or connect to these utility access terminals, enabling synergistic use of urban infrastructure spaces while minimizing the environmental and physical footprint of the system's installation.

In one or more embodiments of the invention, the pipe segments are designed to support the transit of pods. The pipe segments are optionally constructed from materials such as high-density polyethylene (HDPE), chosen for properties including resistance to environmental degradation and mechanical stress. For example, a pipe segment might measure 20 inches in diameter and extend for up to 2 kilometers, allowing pods to traverse between distribution hubs. Material choice can vary; besides HDPE, alternatives like PVC or reinforced concrete could be used depending on the installation environment, such as underground, underwater, or above ground, to suit varying temperature ranges.

### Network Configuration

The network architecture is designed with flexibility to adapt to diverse operational needs. Pipe segments and junctions can be modularly configured to form networks spanning across multiple environments-including urban, rural, or industrial. The system may be configured to function under different atmospheric conditions, from vacuum to pressurized settings, optimizing for factors such as speed and energy efficiency. For example, in a vacuum-operated segment, pods can accelerate to higher speeds with reduced energy consumption, facilitating long-distance transportation between cities in reduced times, potentially cutting travel times significantly compared to traditional ground transportation methods.

In one or more embodiments of the invention, the pipe delivery system includes an unpowered infrastructure designed to facilitate the movement of pods without the use of powered mechanisms within the pipe segments themselves. In some embodiments, this unpowered infrastructure may include segments of pipe that are either vacuum or slightly pressurized to create a conducive environment for the pods to move with reduced friction and resistance.

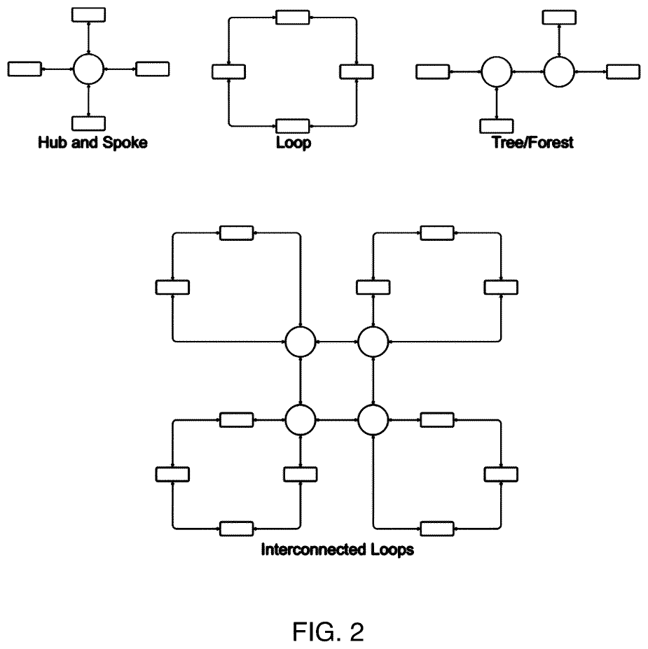

FIG. 2 depicts a set of different example pipe delivery system layouts that may be suited for various applications depending on infrastructure cost, accessibility of land or easements, excavation/installation cost, transit/delivery times, and more. In the example of FIG. 2, the rectangle entity represents a destination terminal, the circle represents a junction, and connecting lines and arrows represent pipe segments. As illustrated, the example layouts include a “hub and spoke” design, a “loop” design, a “tree/forest” design, and “interconnected loops.” A variety of different layouts and combinations of layouts may exist, including but not limited to those illustrated in the provided examples.

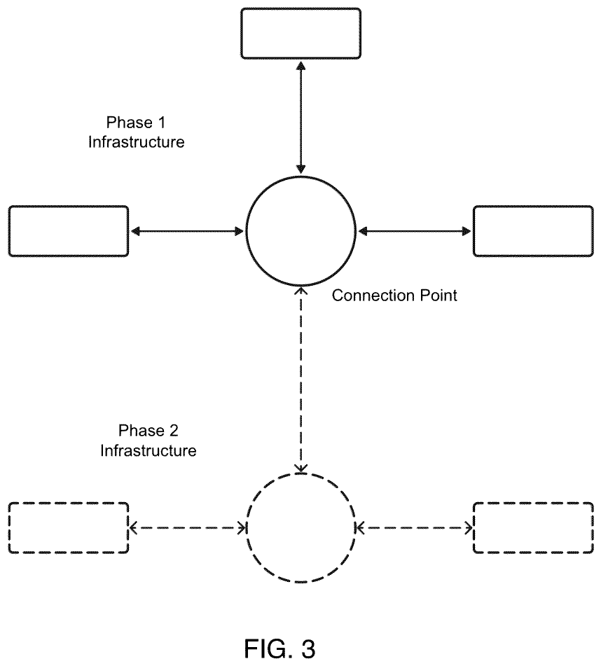

FIG. 3 depicts an example of a network layout of an existing pipe delivery system (“Phase 1 Infrastructure”) along with an example of a layout of a proposed extension to the network (“Phase 2 Infrastructure”) tied together by a connection point at a junction location. This figure illustrates the extensibility of the system's design, enabling the network to adapt and grow without service disruption (or with minimal disruption) and with minimal impact to existing infrastructure.

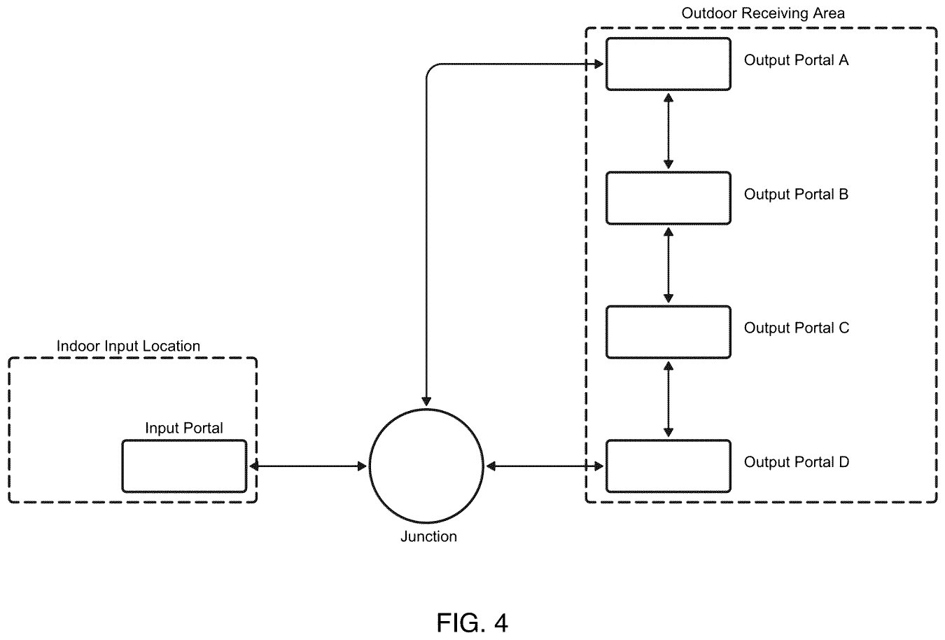

FIG. 4 depicts a schematic diagram of a “First Inch” network layout including a junction, two terminals (“Indoor Input Location” and “Outdoor Receiving Area”) and multiple portals (Input Portal, Output Portal A, Output Portal B, Output Portal C, Output Portal D) interfacing with an underground pipe network. This example layout illustrates an implementation whereby the pipe delivery system includes the first touch point from the package sender. First-inch designs can include the terminal locations performing picking and packaging, initial sorting and labeling, and first point of departure (e.g., from an inventory location embedded in the terminal).

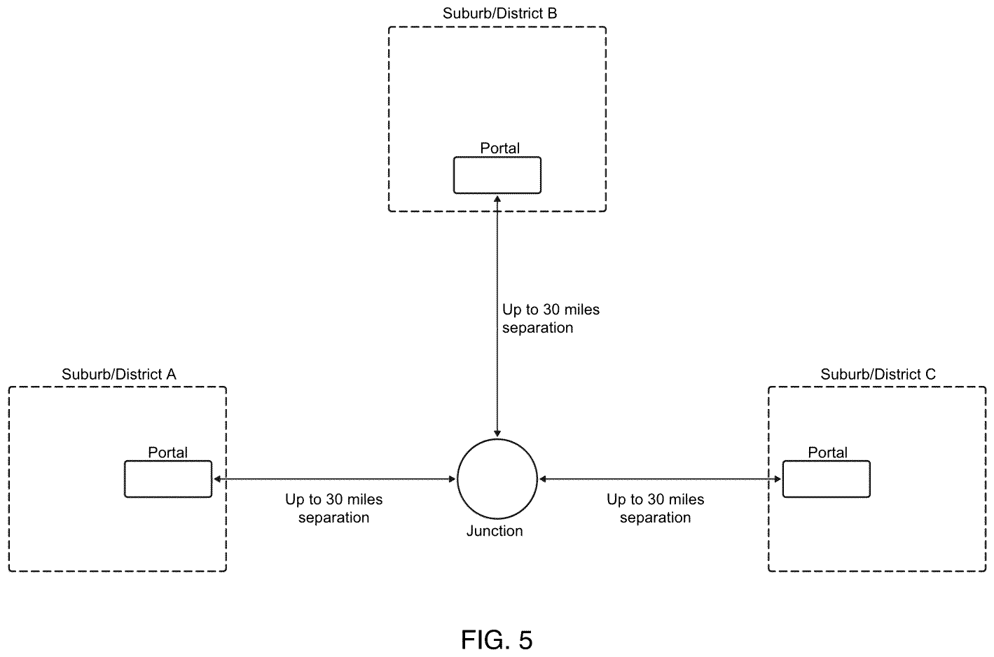

FIG. 5 depicts a schematic diagram of a “Middle Mile” network layout including a junction, three terminals (“Suburb/District A”, “Suburb/District B”, and “Suburb/District C”) and multiple portals interfacing with an underground pipe network. This example layout illustrates an implementation whereby the pipe delivery system interfaces with other logistics and delivery systems for intake and output of packages at the terminal locations. For example, terminals can include pickup points for last-mile services, receiving docks for dropoff by delivery trucks, and more.

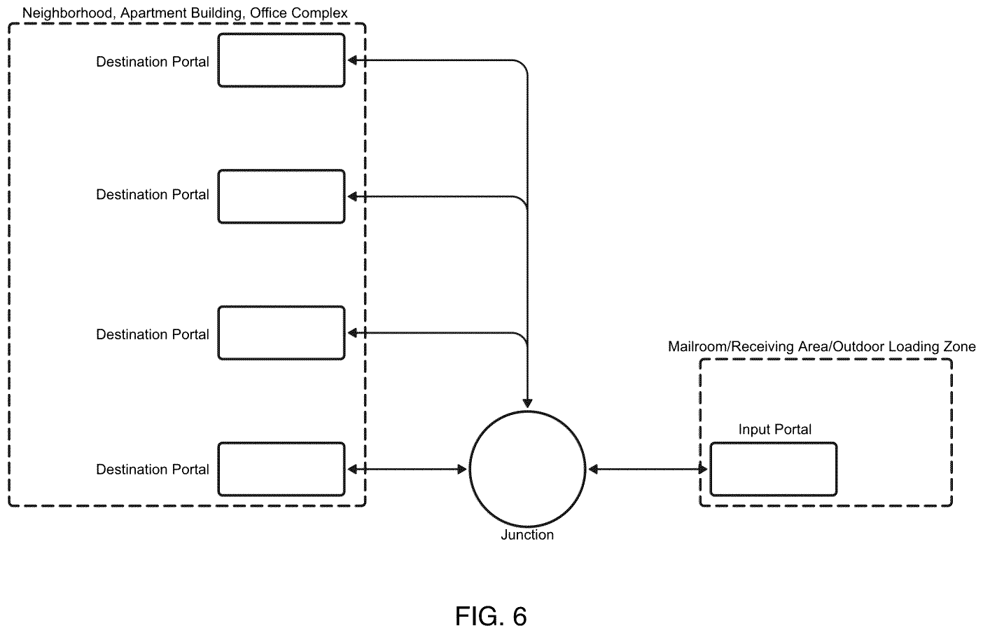

FIG. 6 depicts a schematic diagram of a “Last Inch” network layout including a junction, two terminals (“Neighborhood, Apartment Building, Office Complex” and “Mailroom/Receiving Area/Outdoor Loading Zone”) and multiple portals (Input Portal, Destination Portals) interfacing with an underground pipe network. This example layout illustrates an implementation whereby the pipe delivery system includes the last touch point to the package recipient. Last-inch designs can include the terminal locations providing an interface for the recipient of the package to directly acquire their package.

In one or more embodiments of the invention, the pipe network is structured to enhance directional flow through the use of dual-pipe configurations and integrated turnabouts. This design may enable efficient traffic management and reduce potential bottlenecks. For example, the pipe network may include two parallel pipe segments for certain routes, each designated for one-way traffic. This dual-pipe setup allows for continuous, unidirectional flow in each pipe segment.

In one or more embodiments of the invention, the pipe network includes one or more turnabouts. These turnabouts are essentially junctions that allow pods to switch from one pipe to the other without requiring a complete stop. This enables a continuous flow of traffic within the system, especially in high-density areas or during peak operational times. The turnabout may enable pods to reverse direction in a dual-pipe configuration by transitioning to a parallel pipe segment. An exit latch may be triggered by the approaching pod via wireless communication, triggering a mechanism for the pod to be diverted into the turnabout. This mechanism is synchronized by the logistics server to minimize waiting times and optimize the flow of pods through the network.

In one or more embodiments of the invention, the unpowered pipe segments in this system may operate under a vacuum, where the internal pressure is significantly lower than the atmospheric pressure outside the system. This vacuum environment reduces air resistance, allowing pods to move more smoothly and with less energy consumption. Alternatively, certain segments might not be under a vacuum but instead use a controlled pressurization system where gasses lighter than air, such as helium or hydrogen, are used to fill the pipes. These lighter gasses reduce the density of the medium inside the pipe, thereby decreasing drag on the pods as they travel and may include other beneficial properties.

In one or more embodiments of the invention, to enhance the movement of pods within these unpowered segments, slight air motion or directionality may be employed using fans. These fans are strategically placed at intervals along the pipe to propel a gas medium in the direction of pod traffic. By aligning the airflow with the direction of the pods' travel, the system minimizes the energy required for pod propulsion, thereby optimizing the efficiency of the delivery system.

### Guide Rail

In one or more embodiments of the invention, one or more of the pipe segments optionally incorporate a guide rail that runs along the interior, directing the pod's movement. The guide rail is configured to maintain the pod's course during traversal of the pipe segment. The rail may be fabricated from materials that balance strength and low friction, such as steel or aluminum alloys, to withstand the wear from continuous pod traffic while allowing smooth pod movement. A guide rail might have a cross-sectional profile designed to minimize contact resistance, facilitating rapid pod speeds (e.g., up to 100 km/h) without significant loss of energy. In one or more embodiments of the invention, one or more of the pipe segments optionally incorporate the guide rail only in segments of the pipe that include a turning radius, a junction, and/or exhibit forces on the traversing pods that require added stabilization.

In one or more embodiments of the invention, the guide rail system used in the pipe network is not affixed directly to the pipe itself. This design choice allows for the installation or modification of the rail either concurrently with or subsequent to the installation of the pipe. Such flexibility enables the layout of the pipe network to be altered based on changing logistical needs or when maintenance and upgrades are required without disrupting the entire system.

In one or more embodiments of the invention, the guide rail features a flat profile that provides a stable track for the wheels of the transport pods. In one or more embodiments, to enhance stability of the pod, the rail may be designed to at least partially enclose the wheels. This enclosure may help to prevent the wheels from derailing when traveling at higher speeds and/or through junctions or pipe segments with tight turn radii. In one embodiment of the invention, the design of the rail allows it to have side-to-side and vertical flexibility, accommodating slight shifts and movements within the installed environment. However, it possesses minimal rotational or twist flex, which helps maintain the alignment and direction of the pods, preventing misalignment and/or potential derailment.

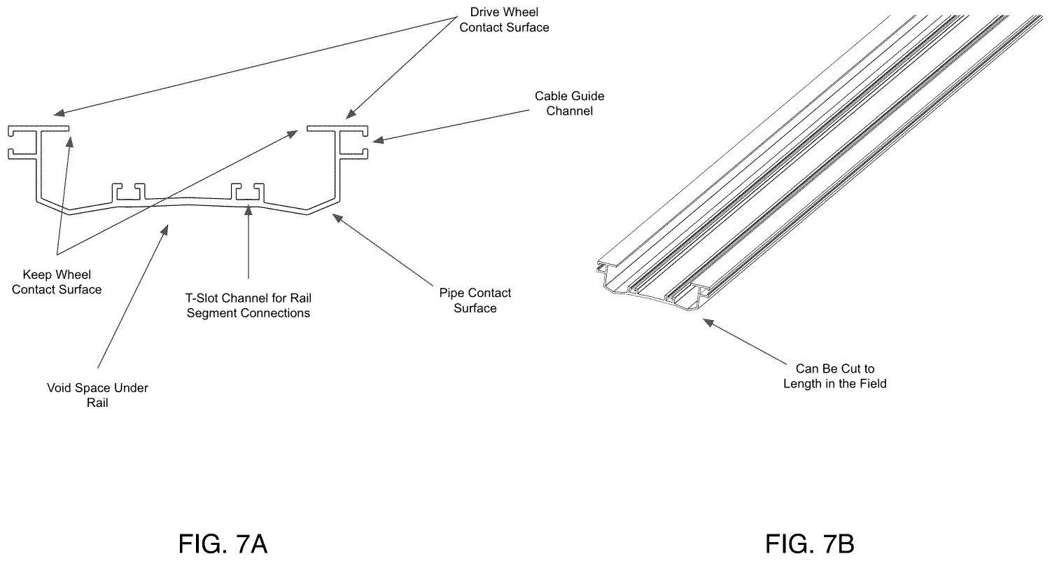

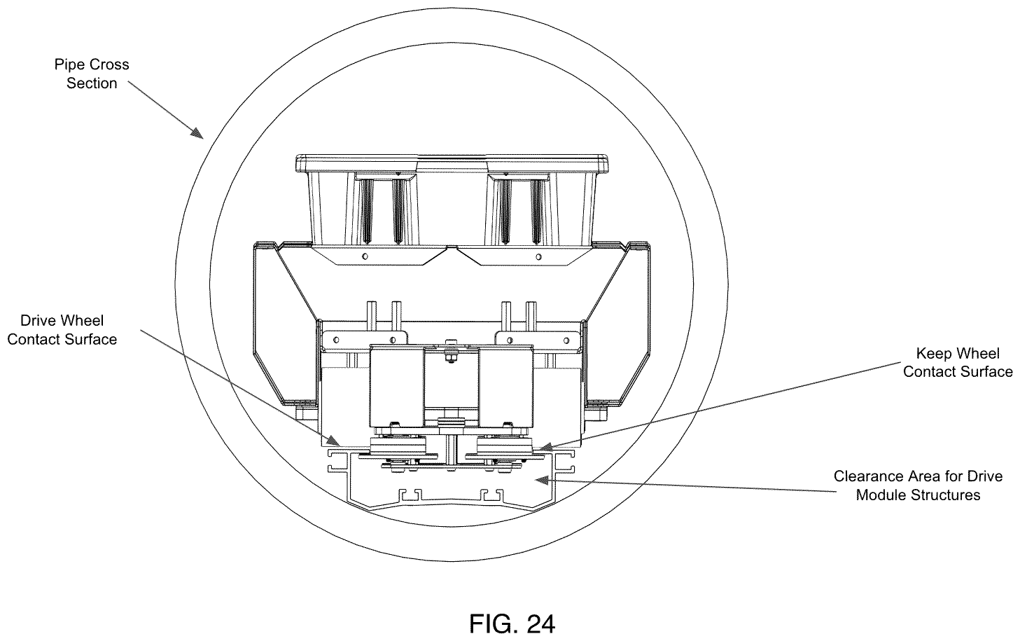

FIG. 7A depicts a cross-section of an exemplary rail guide design, in accordance with one embodiment of the invention. As illustrated in FIG. 7A, the rail guide includes a drive wheel contact surface and a keep wheel contact surface, a cable guide channel, a pipe contact surface, a void space under the rail guide, and a T-slot channel for rail segment connections. In this design, the pod's drive unit includes multiple wheels with different axle locations positioned such that “keep wheels” and “drive wheels” are configured with substantially perpendicular axes and configured to make contact with the keep wheel contact surface and the drive wheel contact surface, respectively. In this design, one or more cables can be routed within the cable guide channel, and the T-slots can be utilized to connect rail guide segments in a modular fashion. FIG. 24 depicts a cross-sectional view of a pod traversing the rail design of FIG. 7A. FIG. 7B depicts an isometric view of the rail guide, illustrating that this design allows for rail guide segments to be cut to length onsite during installation.

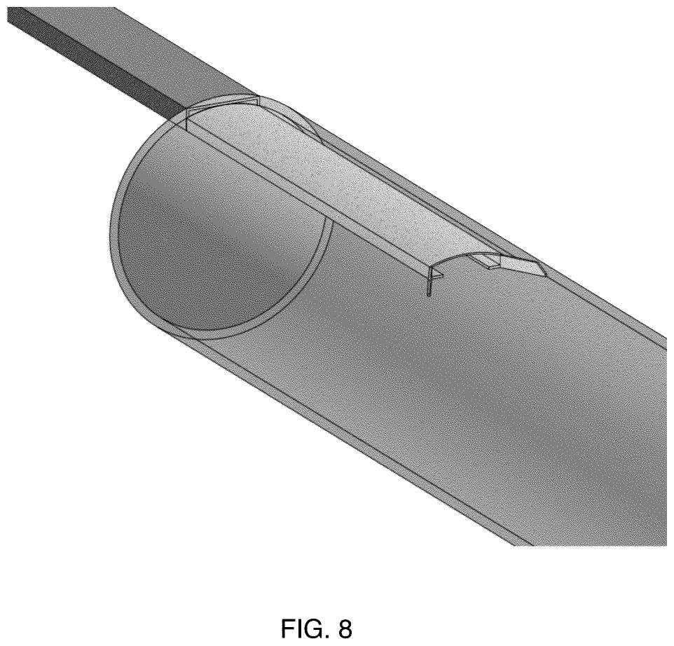

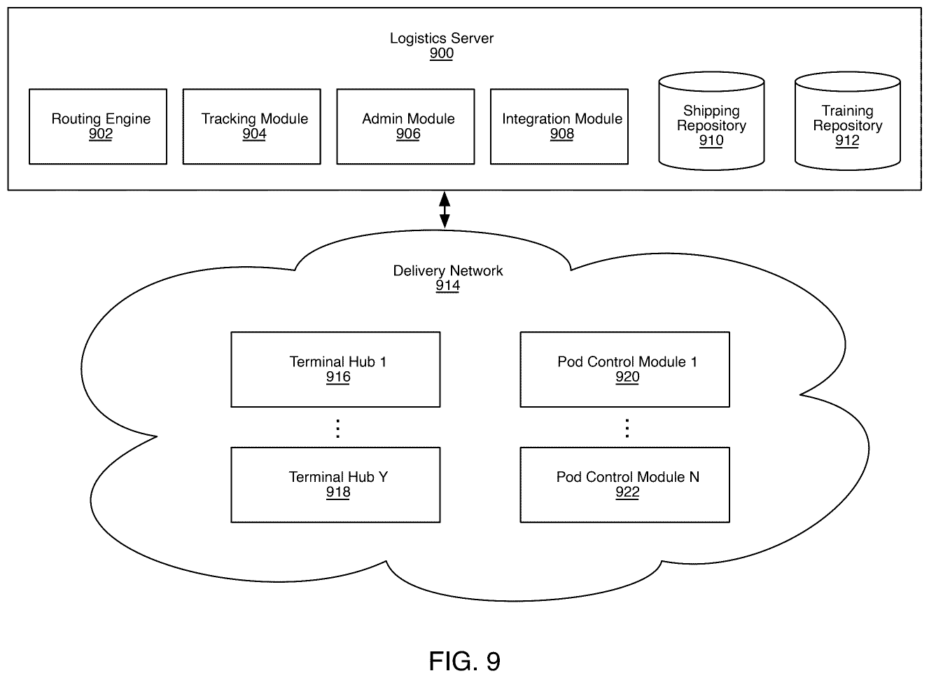

In one or more embodiments of the invention, one of the significant advantages of this rail design is its ability to be integrated into any existing infrastructure without extensive modifications. This capability is particularly useful in applications where space and structural modifications are limited. The rail's non-intrusive installation process means that it does not require the drilling of extensive holes in the pipe walls, which can lead to potential sealing problems, moisture ingress, or root penetration-common issues that may compromise the structural integrity of the pipe network. The ability to install, reinstall, or repair the rail after the pipe has been installed is an important feature. This flexibility allows maintenance teams to perform upgrades or repairs on sections of the rail without the need for complete system shutdowns or extensive excavation. FIG. 8 depicts an isometric view of a rail guide within a pipe segment, in accordance with various embodiments of the invention.

### Turn Radius

In one or more embodiments of the invention, the pod and/or the associated pipe network are specifically designed to navigate small turn radii. Smaller turn radii may enable efficient routing within dense urban environments or complex industrial setups, for example. This capability is achieved through several optional structural adaptations in both the pod design and the pipe network configuration.

In one or more embodiments of the invention, the structure of the pod is designed to allow for flexibility during transit, particularly when navigating turns within the pipe network. This flexibility is facilitated by incorporating joints between pod segments, allowing the pod to articulate or bend at these points. These joints are pivot points that can withstand the dynamic stresses of bending while maintaining the integrity of the pod's structure. The joint may be implemented using a flexible material that bends or may include an actual hinge design. The material used for the pod body may also contribute to this flexibility. For example, high-grade, flexible composites or segmented metal plates can be used, which offer the necessary durability and bendability without compromising the pod's safety or functionality. In one embodiment of the invention, the pods or pod components connect at these joints to create a modular train design where multiple pods can be linked and still navigate turns effectively.

In one or more embodiments of the invention, one or more pipe segments are designed to accommodate smaller turn radii. In particular, in one embodiment, larger custom diameter pipe segments are employed in turning areas to allow more room for the pod to maneuver without excessive tilting or the risk of jamming. These segments might only be present at critical turning points in the network, optimizing the balance between space utilization and system complexity. In these larger pipe segments, a variable diameter design can optionally be incorporated, using spring-loaded suspensions within the pod that adjust the wheel positions dynamically. This adjustment ensures that the wheels maintain optimal contact with the pipe walls, enhancing traction and stability as the pod navigates the turn. Pods with a low center of gravity (COG) may be well-suited to this setup, as their inherent stability reduces the need for complex suspension systems. In one embodiment of the invention, a rail guide is used only in turn segments of the pipe network, or in small diameter turn segments with a turn radius below a predefined threshold.

In one or more embodiments of the invention, the hull of the pod is specifically shaped to enhance its ability to navigate tight turns. This includes designing the hull with a large breaker angle, which reduces the likelihood of the pod's front or rear catching on the pipe walls during sharp turns. Additionally, the hull may feature curvature or angular designs between the wheels or at the corners-akin to an hourglass shape or a design with two connected payload bays. These shapes help to increase the effective breaker angle during navigation, allowing the pod to make tighter turns without increasing the risk of structural interference with the pipe walls.

In one example, a pod is designed with articulated joints and a flexible composite body, traveling through a pipe network where it approaches a tight turn. The turn involves a larger diameter pipe segment specifically placed to facilitate easier maneuvering. As the pod enters this segment, its spring-loaded wheel suspension system activates, adjusting the wheels to maintain full contact with the curved pipe walls. Simultaneously, the articulated joints allow the pod to bend, conforming to the turn radius without compromising speed or safety. The pod's hourglass-shaped hull, featuring enhanced breaker angles, smoothly navigates the turn, minimizing the risk of collision with the pipe walls.

### Logistics Server

FIG. 2 shows a logistics server 200 in accordance with one or more embodiments. As shown in FIG. 2, the logistics server 200 is operatively connected to a delivery network 214 and has multiple components including a routing engine 202, a tracking module 204, and admin module 206, and integration module 208, a shipping repository 210, and a training repository 212. The delivery network includes a variety of communication devices embedded or traversing the pipe network such as terminal/portal hubs (e.g., 216-218) and pod control modules (e.g., 220-222). Various components of the logistics server 200 can be located on the same device (e.g., a server, mainframe, virtual server in a cloud environment, and any other device) or can be located on separate devices connected by a network (e.g., a local area network (LAN), the Internet, a virtual private cloud, etc.). Those skilled in the art will appreciate that there can be more than one of each separate component running on a device, as well as any combination of these components within a given embodiment.

In one or more embodiments of the invention, the logistics server serves as a central control unit for managing the operation of a pipe delivery system. The logistics server is equipped with several modules: a routing engine, a tracking module, an admin module, and an integration module.

### Routing Engine

In one or more embodiments of the invention, the routing engine includes functionality to perform routing of pods and totes based on a variety of inputs. In this way, the logistics server uses the routing engine to maintain an overarching view of the network's status and route pods accordingly. The routing engine may be configured to employ a machine learning model to analyze patterns of network usage, anticipate areas of congestion before they occur, and reroute pods proactively. The engine may be configured to orchestrate the movement of multiple pods to distribute traffic evenly across the network, preventing congestion before it starts by adjusting routes in anticipation of increased demand in certain segments.

In one or more embodiments of the invention, the routing engine is programmable and designed to tailor the travel path of one or more pods based on the specific requirements of the payloads they carry. This programmability allows the routing engine to handle complex logistics operations from manufacturing facilities directly to consumers, covering end-to-end delivery processes. The routing functionality of the system can be implemented in various forms including centralized, decentralized, or partially decentralized systems. In decentralized embodiments, pods are capable of making autonomous routing decisions, which may involve rerouting in response to operational conditions without central oversight. The server is configured to periodically synchronize with the pods, and if a pod fails to synchronize within a predetermined timeout period, the server takes predefined corrective actions to ensure service continuity.

### Tracking Module

In one or more embodiments of the invention, the tracking module includes functionality to monitor the real-time location and status of pods within the system. This tracking module ensures that all aspects of the delivery process are visible to logistics managers and enables automation of the recovery process in case of delays or interruptions.

In one or more embodiments of the invention, the tracking module utilizes a network of beacons installed along the pipe segments to determine the precise location of each pod. These beacons emit signals that are picked up by receivers on the pods, enabling the tracking module to continuously update the location data in real time. This feature allows logistics operators to monitor the exact position of all active pods within the network, enhancing the ability to respond rapidly to any operational anomalies that may arise.

In one or more embodiments of the invention in addition to location tracking, the tracking module is configured to monitor the condition of both the pods and the cargo they carry. This is achieved through a combination of sensors installed within the pods, including temperature sensors, humidity sensors, and shock detectors. The data collected by these sensors is transmitted back to the logistics server, where the tracking module analyzes it to ensure that environmental parameters remain within the pre-set thresholds suitable for the cargo's integrity. Alerts are generated and sent to the admin module if any parameter deviates from its acceptable range, prompting immediate action to mitigate any potential damage to the cargo.

In one or more embodiments of the invention, the tracking module includes predictive analytics capabilities. Using historical data on pod performance and delivery routes, along with real-time data collected during current operations, the tracking module employs a machine learning model to predict potential delays, system malfunctions, or route inefficiencies. This predictive capability enables preemptive adjustments to routes or schedules to optimize delivery times and reduce downtime.

In one or more embodiments of the invention, the predictive analytics model utilized within the tracking module is a type of neural network well-suited for sequential data predictions. This model is specifically chosen for its ability to remember inputs over long periods, which is essential for accurately predicting the state of a dynamically changing logistics network. The model inputs include a range of features collected from both real-time operational data and historical records:
Timestamped location data of pods within the pipe network, providing sequences of pod positions and speeds.
Environmental conditions along the routes, such as temperature and humidity levels recorded by onboard sensors.
Pod operational status, including battery levels, load capacity, and mechanical integrity indicators.
Historical delay incidents, categorized by factors contributing to the delays (e.g., mechanical failures, blockages).

The primary output of the model is a set of predictions that include:
Estimated times of arrival (ETAs) for pods at their destination portals, with a confidence interval (e.g., ETA±2 minutes).
Probability of delay for each segment of the network, expressed as a percentage (e.g., 15% chance of delay on segment XYZ due to predicted maintenance issues).
Predictive maintenance alerts that suggest potential failure points within the system that may require preemptive intervention.

In one or more embodiments of the invention, the predictive analytics model is trained using a dataset stored in the training repository. This repository aggregates a large volume of data including detailed logs of pod movements, sensor readings, system malfunctions, and maintenance records. The training process involves several steps including data preprocessing, feature engineering, model training, and test/validation.

In one or more embodiments of the invention, once trained, the predictive analytics model is deployed within the logistics server's tracking module. It operates in real-time, continuously receiving updated data streams from the logistics network. The model re-trains periodically (e.g., weekly) to incorporate new data and adjust its predictions based on the latest trends and changes in the network operations.

In one or more embodiments of the invention, the tracking module includes functionality to perform dynamic rerouting. If a pod encounters an obstacle, such as a blocked pipe segment or a mechanical failure, the tracking module can autonomously initiate a route change for the affected pod as well as notify other pods in the vicinity to take alternate routes. This rerouting is managed in real-time, with decisions supported by the comprehensive situational awareness provided by the continuous data flow from the pods and the network infrastructure.

In one or more embodiments of the invention, the tracking module incorporates features designed to detect unauthorized access or tampering with the pods or their cargo. Utilizing a combination of security cameras, motion detectors, and tamper sensors integrated within the pod design, the module can trigger immediate alerts to the admin module and local security personnel if security breaches are detected. In one example, this may be utilized for ensuring the safety and integrity of high-value or sensitive cargo.

In one or more embodiments of the invention, the tracking module offers extensive integration capabilities with external logistics systems, enabling seamless data sharing and coordination. By standardizing the communication protocols and data formats, the tracking module ensures that information regarding pod status and location can be easily accessed by partnering logistics services, eCommerce platforms, and end-users through a secure API. This integration may enhance the transparency of the delivery process and improve customer satisfaction by providing end-users with up-to-date information about the status of their orders.

### Admin Module

In one or more embodiments of the invention, the admin module serves as the administrative control center for the pipe delivery system. The module provides comprehensive tools for system configuration, monitoring, and intervention, enabling administrators to maintain operational conditions and manage various system aspects efficiently.

In one or more embodiments of the invention, the admin module allows system administrators to configure and customize settings that dictate operational parameters of the logistics network. Through a user interface (e.g., a web portal), administrators can set parameters such as maximum load capacities for pods, define operational hours for different segments of the network, and adjust routing protocols based on observed delivery efficiencies and external factors like traffic and weather conditions. For example, administrators might restrict heavy cargo loads from traveling during peak hours to prevent slowdowns in critical segments of the network.

In one or more embodiments of the invention, the admin module includes a real-time monitoring dashboard. This dashboard provides a graphical representation of the logistics network, displaying the current status of active pods, ongoing maintenance activities, and any alerts or anomalies detected by the system. The dashboard enables quick identification and resolution of issues, such as rerouting pods around a blocked segment or addressing a sudden spike in delivery requests.

In one or more embodiments of the invention, the admin module is equipped with an incident management system that logs and categorizes issues based on severity and type-ranging from minor mechanical malfunctions to critical system outages. This system records incidents and then guides administrators through a structured response protocol. For example, in case of a pod failure, the system could automatically generate a ticket, notify the nearest maintenance crew, and provide step-by-step guidance based on previously successful resolution strategies.

In one or more embodiments of the invention, the admin module incorporates automated compliance checks. These checks are periodically performed to verify that all system components are operating within legal and safety parameters. If a potential compliance issue is detected, the module can initiate corrective measures automatically, such as adjusting pod speeds or rerouting deliveries through safer pathways.

In one or more embodiments of the invention, leveraging data from the tracking module's predictive analytics, the admin module schedules maintenance for the pipe network and its components. This feature uses a predictive maintenance model that analyzes historical and real-time data to forecast when and where maintenance should be performed to prevent unplanned downtime. For instance, if the model predicts a high likelihood of wheel assembly failures in certain pods, the admin module can schedule preemptive repairs or replacements during off-peak hours to minimize impact on service.

In one or more embodiments of the invention, the admin module includes functionality to integrate with external data systems. This integration allows the logistics server to adjust its operations in response to external events. For example, if a severe weather alert is issued, the admin module can proactively reroute pods away from affected areas, or temporarily suspend operations to ensure safety.

### Integration Module

In one or more embodiments of the invention, the integration module enables the logistics server to connect with external systems, including those of merchants, partners, and third-party service providers. This module may utilize standardized data models to simplify integration and ensure compatibility across different logistics ecosystems. In one or more embodiments of the invention, the integration module acts as the interface between the logistics server and external systems. It allows third parties to interact with the logistics network by providing them with access to a variety of services such as dynamic routing options across multiple modes of transportation, economic and cost calculations for shipping, and more. These capabilities are exposed through an application programming interface (API) of the integration module that partners can use to programmatically integrate their systems with the pipe delivery system.

Consider an example scenario where a consumer electronics manufacturer uses the pipe delivery system to send products directly to consumers. The manufacturer provides parameters such as pickup time, latest drop-off time, and product dimensions through the API. The logistics server's integration module receives these parameters and passes them to the routing engine. The routing engine, utilizing its programmable nature, calculates the optimal route considering factors such as delivery urgency, product fragility, and cost efficiency. The calculated route might involve transitions between different transportation modes-such as from underground pipe networks to surface delivery vehicles-handled by the routing engine's capability to integrate multimodal transportation options. Once the route is determined, the tracking module continuously monitors the pod's progress towards its destination, providing real-time updates to both the logistics server and the external partners via the API. In case of a delay or deviation from the planned route, the tracking module alerts the admin module, which then implements contingency plans to rectify the situation, ensuring timely delivery of the products.

In one or more embodiments of the invention, by standardizing the data model for integrations, the logistics server streamlines onboarding of new partners and simplifies the process of scaling operations across different regions and transportation modalities.

### Communication

In one or more embodiments of the invention, the logistics server includes functionality to communicate with pods, either directly or indirectly. In one example, the logistics server, which could be seen as the system's central command, optionally communicates with pods using long-range wireless technologies like 4G LTE or 5G. In one or more embodiments, the logistics server communicates with pods using intermediary devices such as destination terminal network devices, junction network devices, navigation beacons, and/or other components enabling communication with pods traversing the pipe network. Furthermore, in one or more embodiments, the logistics server is configured to send route updates and operational commands to the pods, and to process the data received to manage traffic and respond to dynamic conditions within the network.

In one embodiment of the invention, the logistics server communicates with pods using a combination of Wi-Fi and cellular networks (LTE). This dual communication strategy ensures that pods remain connected to the central server throughout their journey, regardless of their location within the pipe network. For instance, a pod traveling through a remote section of the pipe network might switch from Wi-Fi to LTE to maintain its connection with the server. This enables it to receive updates about its route or any emergency instructions that need to be followed. The server uses this connectivity to monitor the location and status of each pod, optimizing the overall operation of the delivery system.

In one or more embodiments of the invention, communication devices are embedded in the infrastructure at beacons, terminals, and/or junctions of the pipe network. These devices can perform various functions, including data transmission to and from the logistics server, and local processing of pod and tote data at terminals. They might be powered by sustainable sources, such as solar panels, or connected to the main electricity supply, depending on the specific installation location and operational requirements.

In one or more embodiments of the invention, Radio Frequency Identification (RFID) technology is employed to create passive beacons within the pipe delivery system. These passive beacons are strategically placed along the pipe segments to serve as fixed markers that assist in navigation and system monitoring without requiring an independent power source for active signaling. Each passive beacon includes an RFID tag encased in a durable material compatible with the environmental conditions of the pipe network (e.g., moisture, pressure variations). These RFID tags are programmed with unique identifiers and potentially additional data relevant to their location, such as turn instructions or proximity warnings.

In one example, as a pod travels through the pipe network, it activates its onboard RFID reader, which is designed to pick up signals from the passive beacons. When the pod comes within the operational range of a beacon (typically a few meters), the RFID reader detects the beacon's tag and retrieves the stored data. For instance, if a pod approaches a junction, the RFID tag in the beacon at this location may contain data specifying which turntable setting to activate, guiding the pod to its correct exit.

In one or more embodiments of the invention, these RFID tags store dynamic data, which can be updated by maintenance personnel or automatically through network commands from the logistics server. This data might include real-time traffic updates, maintenance schedules, and/or temporary route changes due to construction or system upgrades, enhancing the adaptability of the system.

### Junction

In one or more embodiments of the invention, the pipe network includes one or more junctions. Junctions are mechanisms allowing for the redirection of pods from one pipe segment to another. For example, a junction may be equipped with a turntable configured to rotate to align pods with one of a set of adjoining pipe segments.

In one or more embodiments of the invention, the junction includes functionality to wirelessly communicate with one or more pods. This may include pods approaching the junction and/or pods within proximity of the junction. A junction may be configured to handle pods arriving at a maximum interval (e.g., 10 seconds), swiftly orienting each for continuous flow towards various destinations. The design ensures minimal wait times, for example, less than 5 seconds for pod redirection, maintaining system throughput.

In one or more embodiments of the invention, the junction includes a turntable mechanism that allows the pod to be reoriented in the required direction without the need for the pod to stop and reverse. Upon arrival at the junction, the pod lands on the turntable which is embedded in the intersection of the pipe network. This turntable can rotate in any required direction, aligning the pod with the appropriate exit pipe segment. In some embodiments, the turntable is designed to operate vertically, allowing the pod to be lifted and turned, which is particularly useful in dense network configurations or where vertical integration is necessary due to infrastructure constraints. In one embodiment, the powering of this turntable is pneumatic, utilizing air compressors that quickly adjust the platform's orientation with minimal noise and vibration. In one or more embodiments of the invention, the junction is designed to allow for continuous flow of pods without requiring the pods to stop.

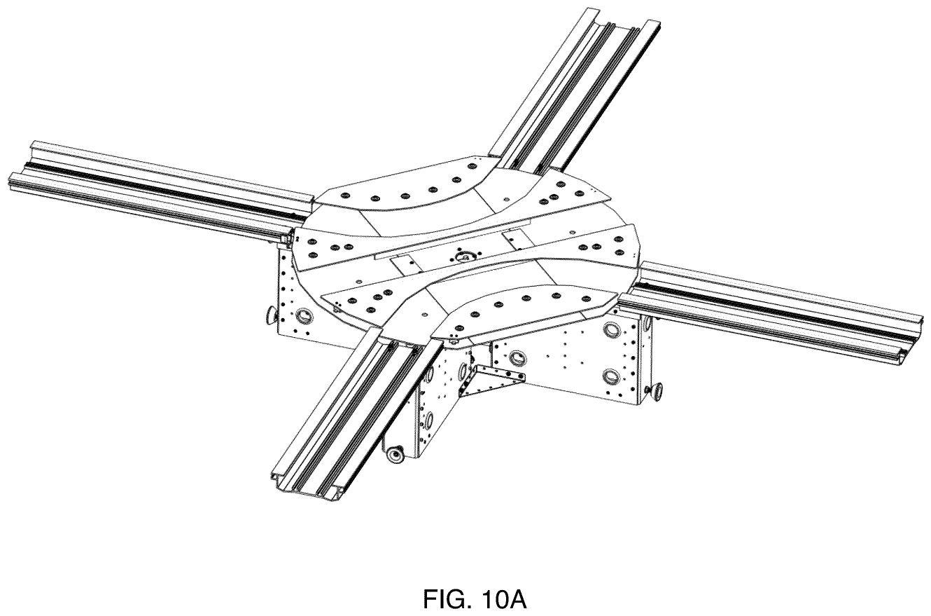

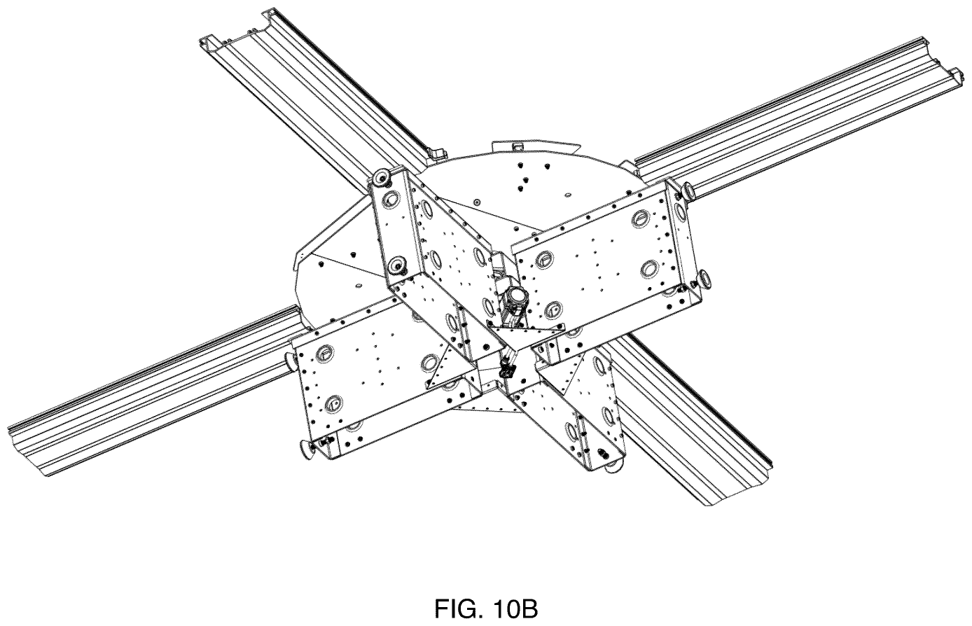

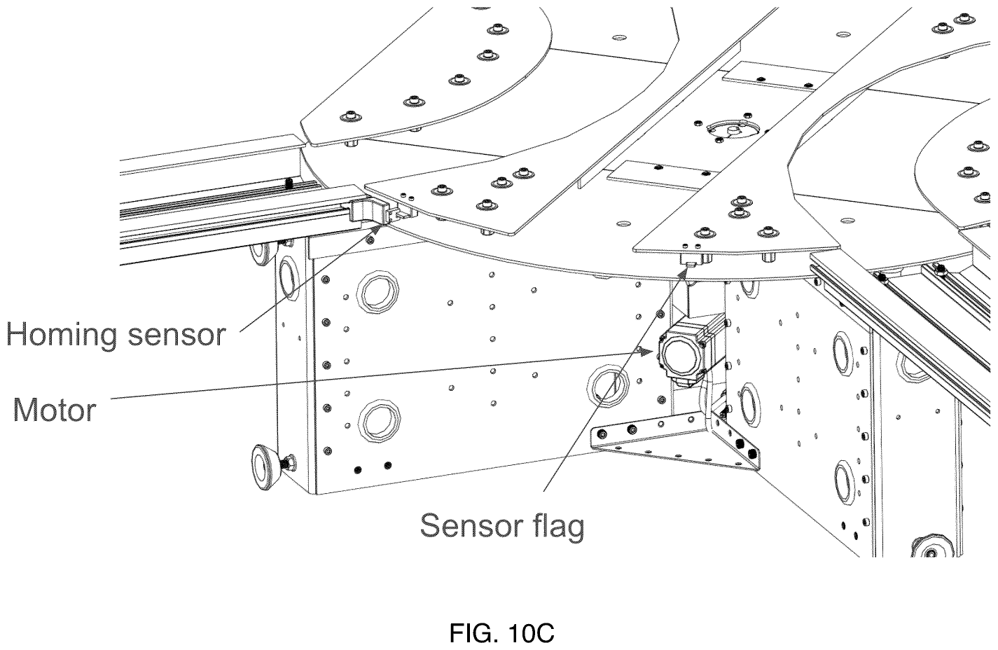

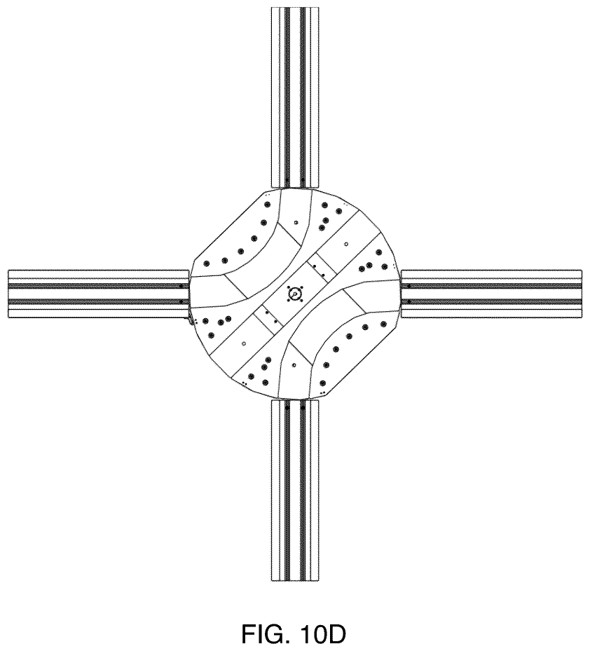

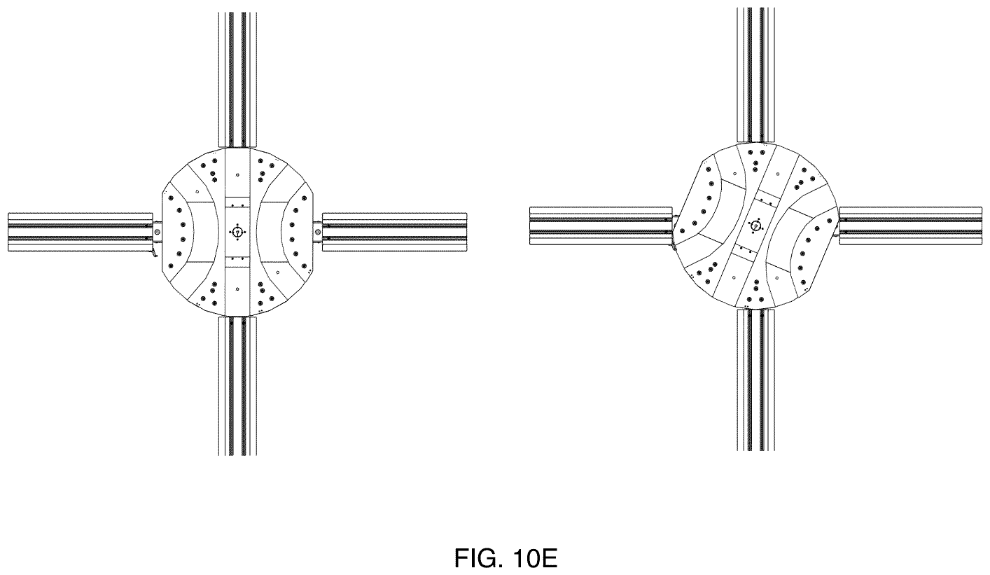

FIGS. 10A and 10B depict an example upper isometric view and lower isometric view of a turntable junction design, respectively, in accordance with one or more embodiments of the invention. FIG. 10C depicts a partial isometric view of the junction, illustrating a homing sensor, a sensor flag, and a motor. In this example design, one or more homing sensors are mounted at a fixed point relative to the rail or pipe segment(s), while one or more sensor flags are mounted to the rotating turntable. The motor is configured to rotate the turntable in either direction (clockwise or counter-clockwise), in response to commands from the logistics server and/or in response to inbound communication from one or more pods (depending on the communication/control design of the system).

Continuing the example of FIGS. 10A-10E, in one or more embodiments of the invention, the homing sensors are positioned next to each rail that connects different pipe segments. Their primary function is to accurately detect the position of the turntable. As the turntable rotates to align with a particular pipe segment, it must stop precisely to ensure a smooth entry or exit path for the robotic pods. The homing sensors detect the sensor flag (or similar markers) on the turntable to determine its exact position. This ensures that the turntable is correctly aligned with the desired rail, minimizing errors and avoiding potential collisions or misrouting of the pods. The sensor flag is mounted on the rotating turntable itself. This flag acts as a target or reference point for the homing sensors. As the turntable rotates, the flag moves with it and passes by the homing sensors. When the flag aligns with a sensor, it triggers the sensor to signal that the turntable is in the correct position for a specific pipe segment. This interaction helps in the precise stopping of the turntable, ensuring that it aligns with the designated pipe segment for the pod to either enter or exit the junction. Together, the homing sensors and the sensor flag work in tandem to control the movement and positioning of the turntable. The alignment allowed by these components helps in maintaining a high throughput in the network and minimizing delays or mechanical wear and tear due to misalignment. FIGS. 10D and 10E depict example top views of the rails and turntable with multiple angle configurations.

In one or more embodiments of the invention, the junction includes a trap door in a straightaway section of the pipe leading to a connected pipe segment. As a pod approaches, it may slow down or stop momentarily over the trap door. The door is then actuated using a magnetic mechanism-magnetic disruptors temporarily disable the door locks allowing them to open only when a pod is precisely over the door, ensuring safe and timely passage into the desired direction.

In one or more embodiments of the invention, the junction employs a Y-junction design where the walls of the pipe can change configuration. These segments are spring-loaded and can shift to create a direct pathway for the pod without it needing to stop. The junction walls may optionally incorporate magnetic or electric actuators that respond to controls from the pod or the logistics server, swiftly realigning the pipe walls based on the incoming pod's destination.

In one or more embodiments of the invention, the speed and air pressure changes caused by the pod as it travels are used to actuate the junction. For example, the increase in air pressure in front of the pod can trigger sensors that prepare the junction to switch configurations, aligning the tracks according to the pod's programmed route.

In a first example, consider a pod traveling at a speed of 10 meters per second approaching a junction equipped with a pneumatic turntable. As the pod enters the junction, it lands on the turntable, which quickly activates and rotates to align the pod with the exit segment leading to its next destination. This process takes place within seconds, minimizing stoppage time and maintaining the flow of other pods in the system.

In another example, a pod approaches a junction where a trap door mechanism is employed. As it reaches the designated point, magnetic disruptors deactivate the lock, and the trap door opens, allowing the pod to continue onto a descending track that merges into another pipe segment. The door then closes behind the pod, readying the junction for the next pod.

### Destination Terminal

For purposes of this disclosure, the term “destination terminal” can refer to either an origin or destination of a pod, i.e., an entry point or exit point to or from the pipe network. In other words, destination terminals are not necessarily limited to being exit points from the pipe network.

In one or more embodiments of the invention, the destination terminal is a hardware system and location for enabling interaction with the pipe network by both internal and external clients. The destination terminal can include any number of optional components, and can consist of anything from a single-portal design to components such as caching, pod transfer/service, last mile integration, and more. In one example, the destination terminal is designed to facilitate the integration of underground or below substrate pipe networks with surface-level operations. In this example, the structure of the destination terminal is configured to accommodate the transfer of goods from the pipe delivery system to external transportation or direct customer pickup.

In one or more embodiments of the invention, the destination terminal structure is configured to interface with a subterranean pipe network. It includes one or more portals that serve as the primary entry and exit points for pods and totes coming from the underground pipe network. These portals are equipped with lift mechanisms that raise and lower pods and/or totes between the underground network and the terminal. The lifting process enables transitioning goods from the below-ground environment of the pipe network to the ground-level activities within the destination terminal.

In one or more embodiments of the invention, the destination terminal includes a multi-level structure to facilitate different stages of payload handling. The lower level contains the entry portals and initial processing areas where items are first received and sorted. Terminal lift mechanisms are utilized for elevating goods to the upper levels, where further sorting, temporary storage, and dispatch operations occur. This multi-level design may enable a more efficient use of space and support a higher throughput of goods moving through the terminal.

In one or more embodiments of the invention, the destination terminal includes a reception area. This area is directly connected to the portals that bring pods and totes up from the underground pipe network. It serves as a point of contact where goods are received, checked for integrity, and prepared for further processing.

In one or more embodiments of the invention, the destination terminal includes a sorting module. The sorting module includes functionality to categorize totes and/or goods based on their destination and priority. This area may utilize automated conveyor systems, robotic handlers, and advanced scanning systems to efficiently direct items to the appropriate storage or dispatch areas.

In one or more embodiments of the invention, the destination terminal includes a terminal tote cache. The terminal tote cache can be configured to store items as an overflow for the portal cache locations, as a mechanism for temporarily storing goods until the specific route/portal are known, and/or as a temporary storage upon arrival at a destination. These caches are designed to accommodate a variety of tote/item sizes and can be accessed rapidly for retrieval and loading onto outbound transportation. In one or more embodiments of the invention, the terminal tote cache features specialized facilities such as climate-controlled storage for perishable goods, secure areas for valuable items, and customization areas where goods can be packaged or modified before final delivery.

In one or more embodiments of the invention, the destination terminal includes a dispatch area. The dispatch area may be a location where goods are prepared for their final delivery phase (after exiting the pipe delivery system). The dispatch area may include one or more loading docks and/or logistics modules, known as transit connect modules, which facilitate the transfer of goods to different modes of transportation such as delivery trucks, drones, or other last-mile delivery services.

In one or more embodiments of the invention, the destination terminal includes a customer service module. For destination terminals that handle direct customer pickups, service modules provide support and facilities for customers to retrieve their goods. These centers are equipped with kiosks and staffed counters to assist with any inquiries and ensure a smooth handover process.

In one or more embodiments of the invention, the destination terminal is equipped with an entry mechanism that includes an automated Center of Gravity (COG) testing system. The COG testing system may ensure that only pods that meet specific stability and safety standards are allowed to enter the pipe network, thus enhancing the overall safety and reliability of the system. This system may include a platform equipped with sensors and balancing mechanisms designed to assess the stability of the pod based on its load distribution and overall weight. In one example, when a pod arrives at the terminal, it is directed onto the testing platform. The COG testing system calculates the COG based on these measurements, ensuring that it falls within predefined safety parameters. If the pod's COG is found to be within the acceptable range, the system automatically triggers the gate mechanisms to open, allowing the pod to enter the pipe network. Conversely, if the pod fails the COG test, the system activates a holding protocol whereby the pod is either redirected to an adjustment area for rebalancing or rejected from entering the network until corrective measures are taken.

In one or more embodiments of the invention, the pipe delivery system includes various types of specialized terminals, each designed to perform specific functions within the system. These terminals include standard terminals, maintenance terminals, charging terminals, and a variety of other terminal types. Each type of terminal incorporates unique features and functionalities that support the operation of the delivery system.

### Standard Terminals

In one or more embodiments, standard destination terminals, also referred to as delivery terminals, are equipped to handle the insertion and removal of delivery pods and their cargo. These terminals contain one or more portals, along with any number of optional components described herein. A standard terminal may include a tote conveyor system that automatically transports removable totes from the portal location(s) to one or more terminal exit points for pickup by external service providers or partners.

### Maintenance Terminals

In one or more embodiments of the invention, standard destination terminals, maintenance terminals are designed specifically for the servicing and repair of pods. These terminals may include diagnostic equipment and tools for performing maintenance tasks, such as software updates, mechanical repairs, charging and/or battery replacements. The maintenance terminals can be integrated into the pipe network at strategic locations to ensure efficient servicing cycles for the pods operating within the system. For example, a maintenance terminal might be equipped with robotic arms and a set of tools for pod repair. The terminal could diagnose a pod's electrical system malfunction and automatically replace a faulty sensor. The terminal could handle pods of various sizes, for example, accommodating pods up to 2 meters in length and with maintenance bays designed to swivel pods to access components typically on the underside. In one embodiment of the invention, the maintenance terminal includes a service entry configured to enable a human technician to access and repair or service pods. In this configuration, the terminal may include a conveyor/rail system operatively connected to one or more portals and configured to transport pods to an area accessible by the service entry.

In one or more embodiments of the invention, charging terminals provide power replenishment for the electric batteries of the pods. These terminals are strategically placed to align with the travel routes of the pods, allowing for minimal disruption in delivery flow. Pods can engage with charging interfaces that might include contact-based or wireless charging systems to replenish their energy reserves. For example, a charging terminal may use a contactless induction charging system where a pod aligns itself over an induction coil embedded in the terminal floor or within a portal embedded within the terminal. The pod could be charged at a rate of 20 kW, enabling it to regain 80% battery capacity within 30 minutes. The system could be designed to handle multiple pods simultaneously, for example, with each pod positioned over an induction coil spaced 3 meters apart along the terminal.

In various embodiments of the invention, different terminal locations, including standard terminals, may be configured with an interface configurable to enable human or robot interaction with the pods. For example, a standard terminal may include an interface for loading and unloading of removable totes, while a maintenance terminal may include an interface enabling technicians to remove or insert pods from the terminal. Various other configurations of the interface can be utilized.

### Terminal Hub

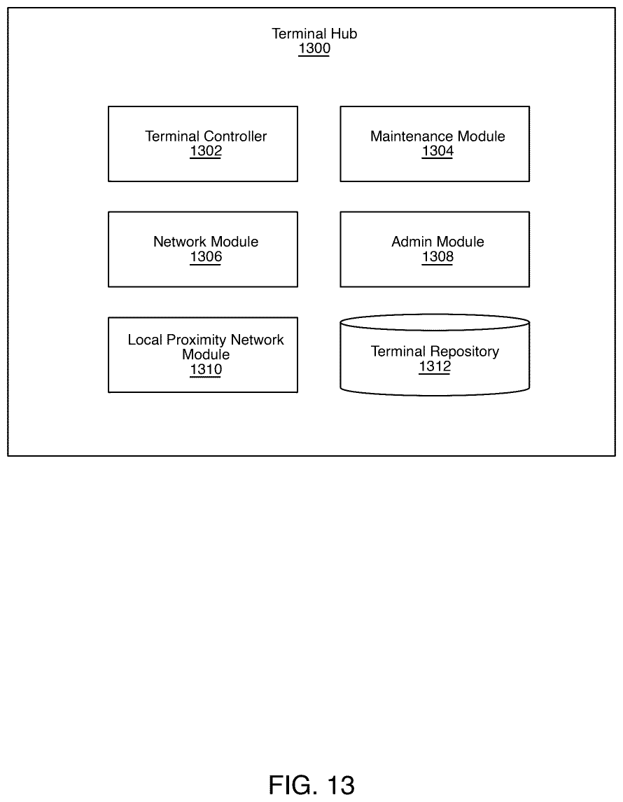

FIG. 13 shows a terminal hub 1300 in accordance with one or more embodiments. As shown in FIG. 3, the terminal hub 1300 has multiple components including a terminal controller 1302, a maintenance module 1304, a network module 1306, an admin module 1308, a local proximity network module 1310, and a terminal repository 1312. Various components of the terminal hub 1300 can be located on the same device (e.g., a server, mainframe, and any other device) or can be located on separate devices connected by a network (e.g., a local area network (LAN), the Internet, a virtual private cloud, etc.). Those skilled in the art will appreciate that there can be more than one of each separate component running on a device, as well as any combination of these components within a given embodiment.

In one or more embodiments of the invention, the terminal hub 300 is embedded within the destination terminal, focusing on control and communication tasks essential to that terminal's operations. The terminal hub may be integrated into the terminal's physical structure via a dedicated computing device that interfaces directly with the terminal's physical components such as sensors, robots, and other devices. This setup allows it to manage interactions and functions occurring at the terminal, such as maintenance tasks, data communication with nearby pods, and more.

In one or more embodiments of the invention, the terminal controller 302 acts as the central intelligence of the terminal hub. This controller is responsible for orchestrating and coordinating the operations of other software modules housed within the hub. It continuously receives and interprets data from various sensors integrated throughout the terminal. For instance, the terminal controller may broadcast signals from ultra-wideband (UWB) beacons to nearby pods. This data helps the pods in real-time decision-making, such as route optimization.

In one or more embodiments of the invention, the maintenance module 304 is configured to perform a variety of maintenance-related functionality. For example, the maintenance module may schedule and dispatch maintenance pods autonomously. The module includes triggers for periodic maintenance tasks, which are activated based on predefined schedules or sensor inputs indicating system wear or malfunction. For example, if a sensor detects a potential blockage or damage within a pipe segment, the maintenance module can dispatch a cleaning or repair pod to address the issue before it escalates.

In one or more embodiments of the invention, the network module 306 is configured to perform communication with various entities across the pipe delivery system. The logistics server may perform coordination and orchestration of tasks across one or more destination terminals by communicating with their terminal hubs via instructions sent through their respective network modules.

In one embodiment, where a UWB beacon is used, communication with the pods is primarily one-directional through broadcast signals from a local proximity network module. This setup allows the hub to send important navigation and operational commands to the pods. In alternative embodiments without a UWB beacon, the network module might support bi-directional communication with the pods, enabling not just command dissemination but also real-time data receipt from the pods. This dual-mode functionality can be utilized for dynamic route adjustment based on traffic conditions within the network.

In one or more embodiments of the invention, the admin module 308 enables interaction with the delivery system through both local and remote administrative interfaces. This module is accessible via a touchscreen interface integrated into the terminal hub. Administrative tasks that can be performed include system configuration, monitoring pod status, and manual override of automated functions in case of emergencies. For example, a local administrator might adjust the frequency of maintenance cycles based on the reported efficiency of the maintenance tasks, while a remote administrator could update the software that controls the routing algorithms.

In one or more embodiments of the invention, the local proximity network module 310 serves as a software interface to a beacon device, such as a UWB beacon, which is integrated into the terminal. In one or more embodiments of the invention, this module enhances the precision of communication with the pods, particularly in densely structured environments where GPS and other signals might be unreliable. The beacon can send location information, navigational data, and/or targeted signals to pods to assist with precise docking maneuvers within the portal stations or maintenance bays.

In one or more embodiments of the invention, the terminal repository 312 is a storage component within the terminal hub. In various embodiments of the invention, it acts as a local cache for sensor data and operational logs essential for the daily functioning of the delivery system, and enables the function of other modules by storing local data necessary for their operation. For instance, sensor data indicating a trend in temperature changes within a pipe segment could be used to predict potential system failures before they occur.

In one or more embodiments of the invention, the terminal hub can be adapted for implementation as a portal hub, integrated within a portal location to serve similar functions within the context of the pipe delivery system. Just like the terminal hub, the portal hub would be embedded within the portal's infrastructure, utilizing a dedicated computing device to manage local, proximal, and remote operations. This adaptation would enable the portal hub to oversee the entry and exit of pods through the portal, coordinate the transfer of totes to and from the pods, and handle communication with pods in immediate proximity. By mirroring the functionality of the terminal hub, the portal hub would ensure efficient localized management of portal-specific tasks, enhancing the coordination and flow of goods through critical points in the delivery network. For purposes of this disclosure, the functionality of said portal hub may generally be described, in certain contexts, as being executed or performed by a “pod controller.”

### Portal

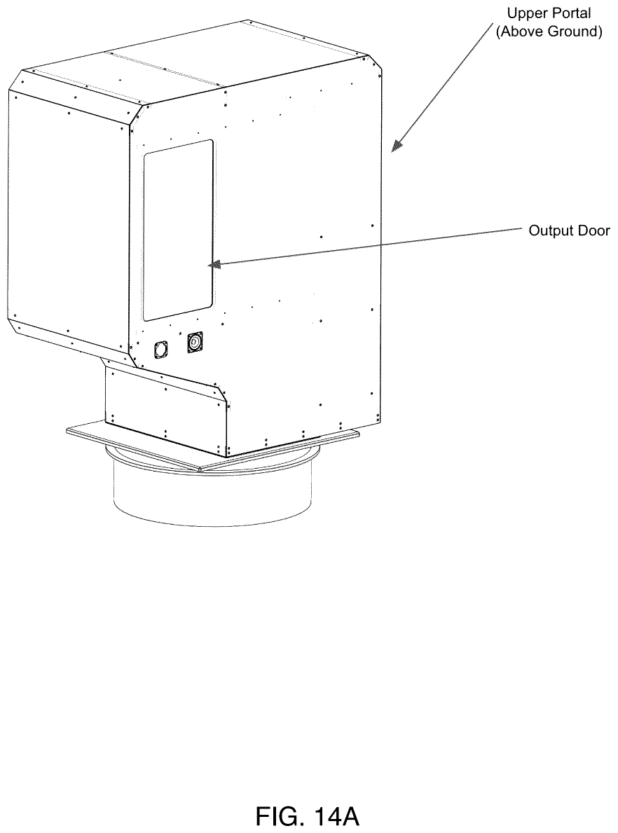

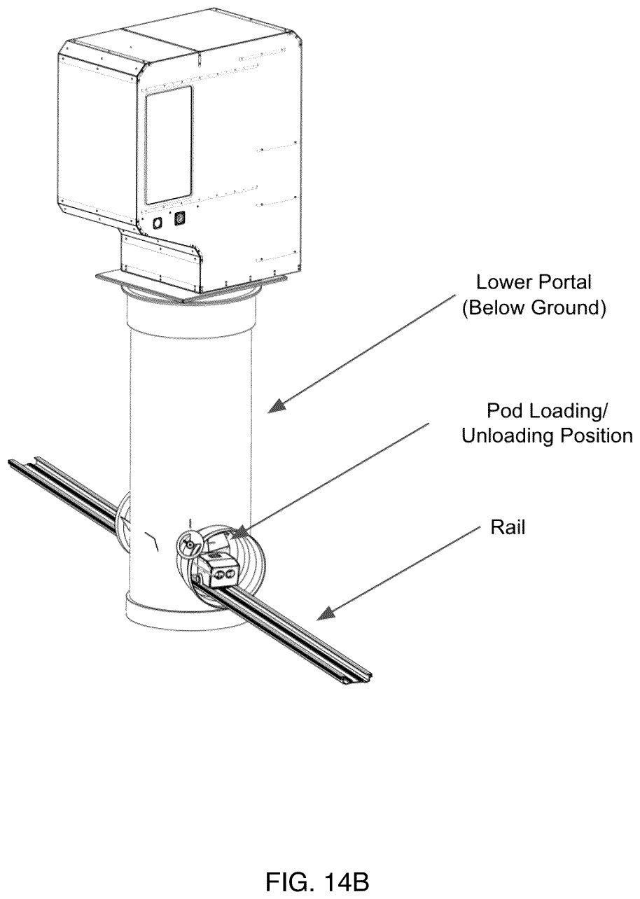

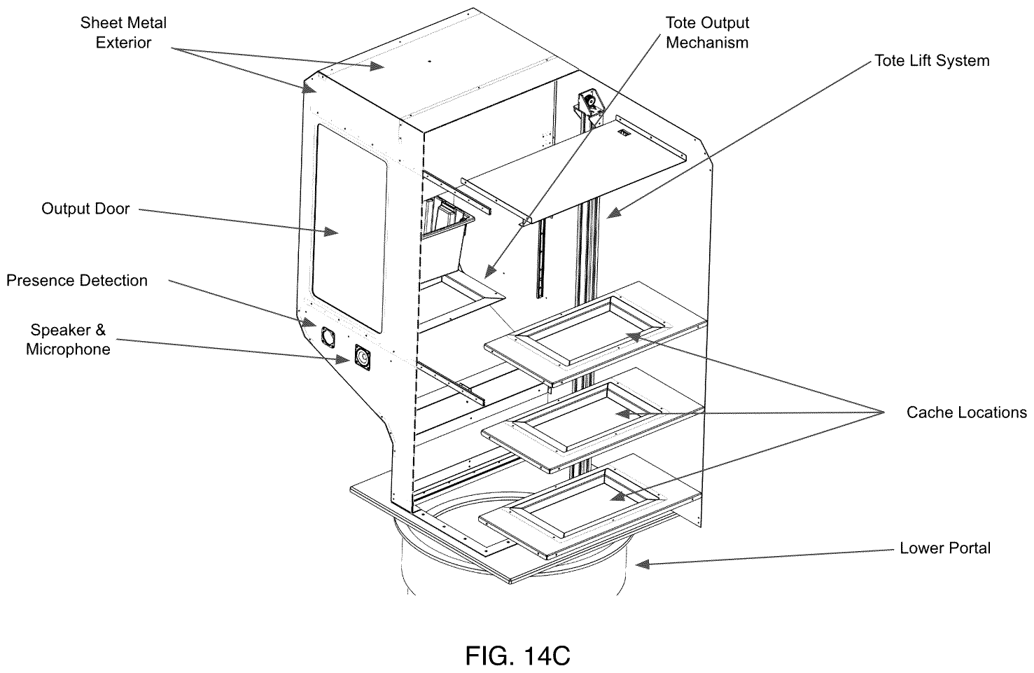

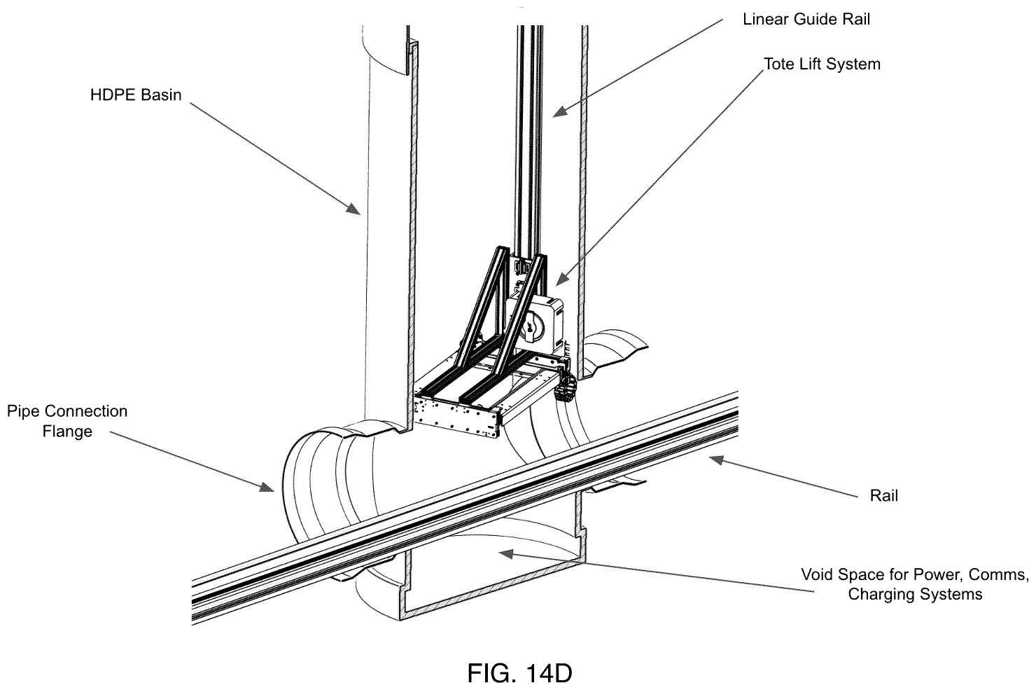

In one or more embodiments of the invention, the pipe delivery system includes one or more portals. A portal is configured to facilitate the insertion and removal of removable totes from the pipe network. This may involve transferring totes to and from pods without the need to remove pods from the guide rail of the pipe network. In one embodiment of the invention, the portal includes distinct upper and lower sections to efficiently bridge subterranean delivery channels with above-ground or higher-level operations. FIG. 14 depicts an example of an above-ground upper portal design, including an output door, while FIG. 14B depicts an example isometric view of the entire portal assembly, including the lower portal, pod loading/unloading area, and the guide rail.

In one or more embodiments of the invention, the upper portal is at least partially positioned at or above a level of the proximate pipe network and includes facilities for interfacing with external entities (e.g., conveyance, delivery vehicle, personnel pick-up). The upper portal may include an output door designed for the secure and efficient transfer of totes to external agents, be they humans or automated systems such as robots. FIG. 14C depicts an example cross-sectional isometric view of an upper portal. In the example of FIG. 14C, the upper portal includes a sheet metal exterior, an output door, a presence detection sensor configured to detect the presence of a receiving entity, a speaker and microphone enabling communication with remote staff, a tote output mechanism configured to enable removal of the totes through the output door, a tote lift mechanism, and various cache locations for temporary storage of totes.

In one or more embodiments of the invention, the lower portal may be situated below ground or substrate level and aligns directly with the pipe network. This section houses a basin that encloses operational mechanisms, including the tote lift system. This basin is designed to provide a robust and protective environment that supports the mechanical components against underground conditions, such as moisture and soil pressure. The basin walls may be constructed using a material appropriate for underground or other applications, such as high-density polyethylene (HDPE). FIG. 14D depicts an example cross-sectional isometric view of a lower portal. In the example of FIG. 14D, the lower portal intersects a pipe segment of the pipe network with pipe connection flanges at the connection points. The lower portal includes a void space at the bottom of an HDPE drain basin and a tote lift mechanism including a linear rail guide for transporting totes to and from the upper portal and cache locations.

In one or more embodiments of the invention, adjacent to the output door, the portal features a tote output mechanism that facilitates the automated transfer of totes to an adjacent service area. This mechanism is typically integrated with conveyor systems, robotic arms, or other forms of automated material handling equipment designed to align with the output door. This setup allows for seamless handoff of goods from the subterranean transport system to ground-level processing or agent interaction zones.

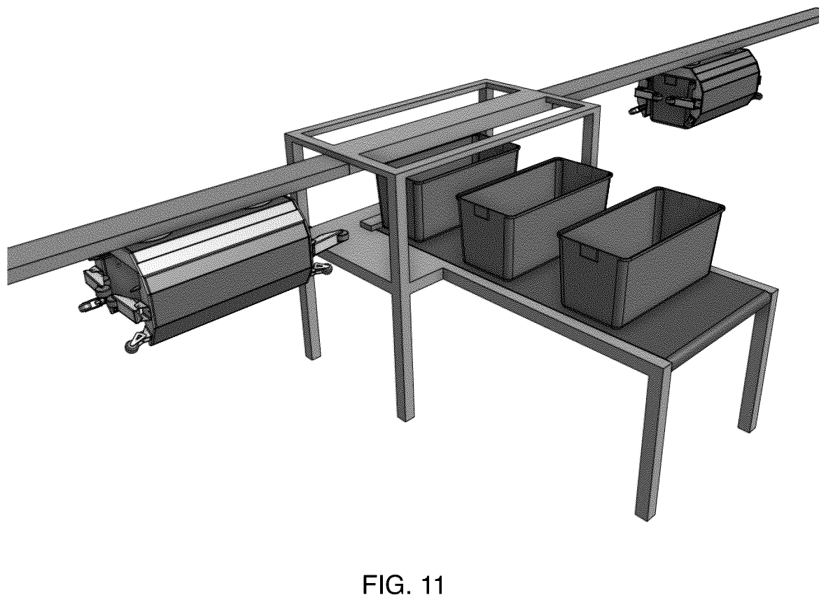

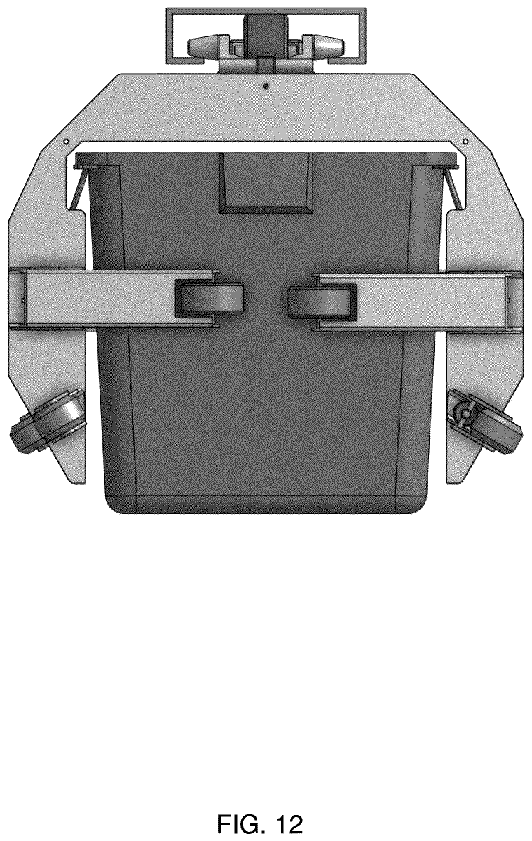

FIG. 11 depicts an example of a tote exchange system, in accordance with various embodiments of the invention. This embodiment involves a tote lift mechanism positioning the entire pod on a rail guide configured to carry the pod (including its removable tote) over a tote conveyor system. The pod includes a gate assembly configured to open in order to receive a tote and to close/lock the tote in position for transport. FIG. 12 depicts an illustration of the gate lock assembly in accordance with various embodiments. In one or more embodiments, the example tote exchange system of FIG. 11 can be incorporated into a portal or terminal, enabling pods to deposit and receive totes with minimal delay. The guide rail of the illustration design can be incorporated or operatively connected with the guide rail of the pipe network to enable seamless traversal of the pod into and out of the pod network, in various embodiments of the invention. Thus, while this design can be implemented and distinct and separated from the pipe network by a gantry or tote lift mechanism, it may also be directly connected and within proximity of a drain basin of the portal.

### Tote Lift Mechanism

In one or more embodiments of the invention, the portal includes a tote lift mechanism. The lift system may include a vertical linear guide rail. This system is responsible for the vertical transportation of totes between the pod and the upper portal. The lift mechanism can raise or lower a tote over any vertical distance. For example, an underground pipe network may require a lift mechanism ranging from 5 to 20 meters, depending on the depth of the pipe network and the design specifications of the portal. In one example, the tote lift is capable of handling loads varying from small parcels up to 200 kilograms with a lift speed designed to optimize throughput while ensuring safety and stability of the cargo.

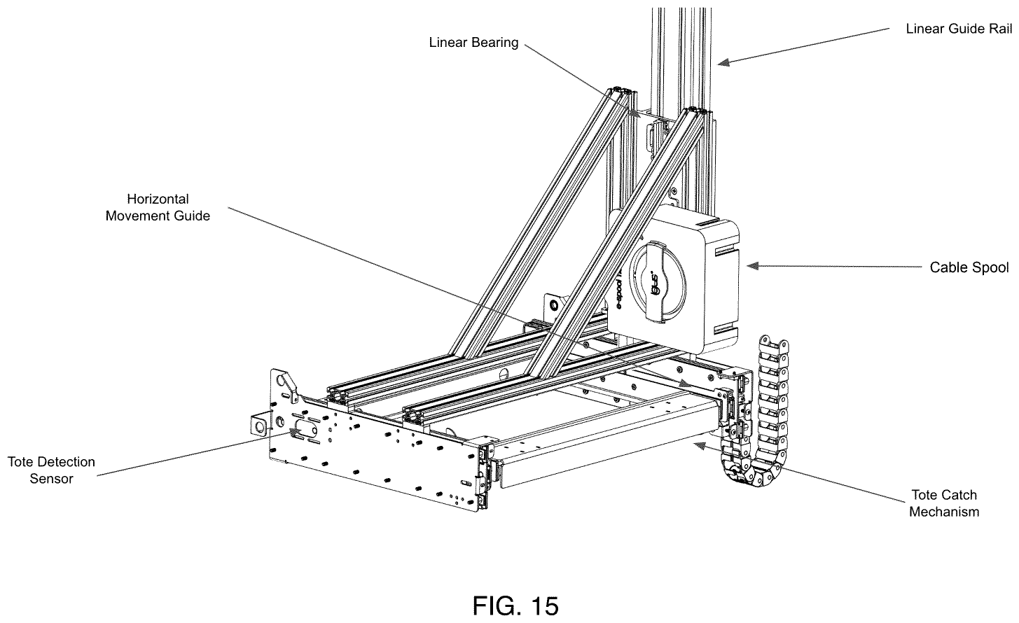

FIG. 15 depicts an isometric view of a tote lift mechanism, in accordance with various embodiments of the invention. As shown in FIG. 15, the tote lift mechanism has multiple components including a horizontal movement guide, a tote detection sensor, a tote catch mechanism, a lift motor, a linear guide rail, and a linear bearing. Those skilled in the art will appreciate that there can be different configurations of these components, as well as any combination of these components within a given embodiment.

In one or more embodiments of the invention, the tote lift mechanism is designed to facilitate efficient handling and placement of totes within a portal. The mechanism incorporates several components that each serve a distinct function in the handling process.

In one or more embodiments of the invention, the horizontal movement guide enables the horizontal transit of the tote across the portal to designated cache locations or other necessary positions. The horizontal guide typically includes a motorized assembly that can shift the tote laterally based on input from the control system, which directs the tote to its intended destination.

In one or more embodiments of the invention, the tote detection sensor is positioned to detect the presence of a tote in the loading or unloading area. Upon detecting a tote, the sensor signals the control system to activate the lift, ensuring that the tote handling process is both timely and responsive to the workflow within the portal.

In one or more embodiments of the invention, the tote catch mechanism is designed to securely lock the tote into the lift mechanism during transport. This component prevents the tote from shifting or falling during movement. The catch mechanism can be implemented as a set of retractable arms or clasps that engage with the tote once it is correctly positioned within the lift.

In one or more embodiments of the invention, the lift motor is operatively connected to the linear guide rail. It powers the movement of the lift across the rail, allowing the tote to be raised or lowered to the appropriate levels within the portal.

In one or more embodiments of the invention, the linear bearings are positioned to enable smooth vertical movement of the system along the rail. This setup minimizes friction and wear, enhancing the longevity and performance of the lift mechanism. The rail and bearings are configured to withstand the loads imposed during the lifting and horizontal movement phases.

In one or more embodiments of the invention, the vertical guide rail of the tote lift mechanism supports a lifting platform equipped with an electric motor and a counterbalance system, which together facilitate the controlled ascent and descent of the totes. The platform is designed to accommodate removable totes of various sizes, securely holding them through one or more mechanical locks that engage during movement to prevent slippage or accidental release. In one embodiment, the lift mechanism uses a precision-engineered motor, typically a servo motor, which provides high torque at low speeds-ideal for the heavy lifting of fully loaded totes. The guide rail may be constructed from hardened steel, aluminum, or an alloy chosen for their strength and durability under repetitive use.

In one example, a tote arriving by pod is automatically transferred onto the lift platform at the lower portal. Once securely positioned, the tote is elevated through the portal's shaft, guided by the linear rail. Upon reaching the upper portal, the tote is mechanically shifted by an arm of the tote lift mechanism onto the tote output mechanism or a cache location for temporary storage. Integrated sensors along the rail monitor the tote's position to coordinate with surface-level operations, ensuring tracking, status updates, and timely availability of the tote for further processing or delivery.

In one or more embodiments of the invention, beneath the guide rails in the lower portal, the designated void space serves multiple functions. It may be utilized for housing power supply units and charging systems that maintain the pods when docked in the portal. Additionally, this space can accommodate communication network devices that enable real-time data exchange between the pods and the terminal's logistics management systems.

For instance, in a typical operation, a pod carrying a tote arrives at the lower portal where it aligns with the tote lift mechanism. The tote, weighing approximately 150 kilograms and containing electronic goods for delivery, is securely clamped to the lift platform. Upon activation, the lift mechanism elevates the tote at a rate of 0.5 meters per second through a vertical shaft of 15 meters, culminating at the upper portal. Upon reaching the upper level, the tote is automatically transferred onto a conveyor that moves it towards the output door where it is staged for last-mile delivery by a drone.

### Portal Cache System

In one or more embodiments of the invention, the portal includes a cache system designed for the temporary storage of totes. This portal cache system may be configured to efficiently manage the interim storage of goods as they transition between the pipe network and surface distribution.

The portal cache system includes one or more storage bays or slots, each designed to accommodate a standard-sized tote. These bays are typically arrayed in a modular grid formation, allowing for scalability and adaptation based on operational needs. The structure is often constructed from durable materials like stainless steel or reinforced composites to withstand the mechanical loads and environmental conditions typical within an industrial setting.

In one or more embodiments of the invention, the external logistics server tracks the status and location of each tote within the cache, ensuring optimized storage management and retrieval efficiency. Sensors integrated into each bay provide real-time data on occupancy and tote status, which feeds into the system's logistics software for streamlined operations.

In one or more embodiments of the invention, upon arrival at the lower portal via the tote lift mechanism, a tote is transferred to the cache system by the automated arm of the tote lift mechanism, which places it into a designated bay. The logistics server receives confirmation of the storage from the portal and updates its status as ‘stored’, and the tote remains in the cache until it is retrieved for surface-level distribution or further processing. Upon retrieval, the tote lift mechanism locates and removes the tote from its bay, transferring it to the upper portal for exit or to another internal processing area.

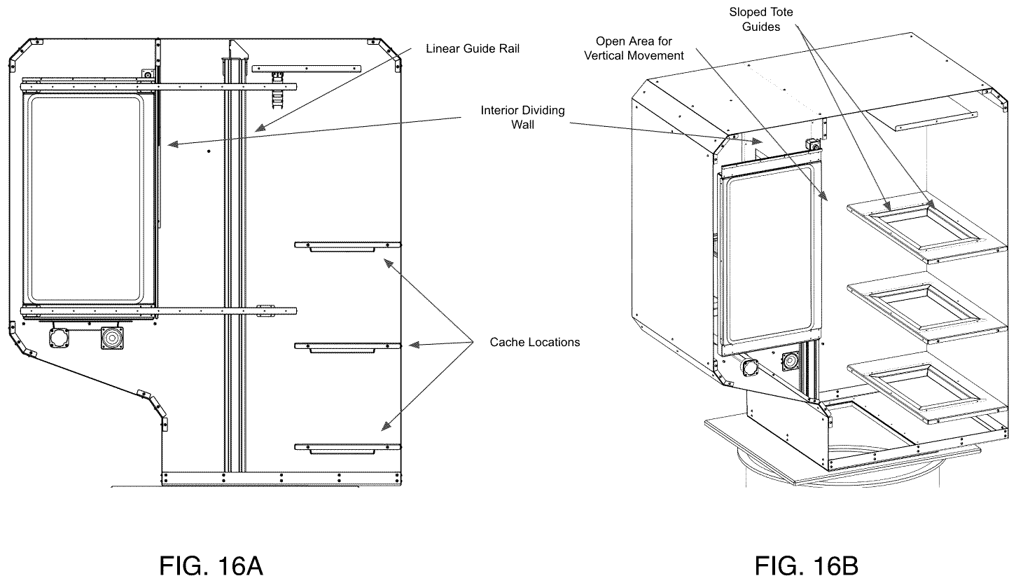

FIGS. 16A and 16B depict cross-sectional isometric views of the upper portal including the cache system. As shown in FIGS. 16A and 16B, the cache system includes multiple cache locations, an interior dividing wall to separate the output section of the portal from the interior, and an open area for vertical movement by the tote lift mechanism.

In one or more embodiments of the invention, the portal cache system incorporates adjustable bay configurations that are configured to expand or contract based on the volume and size of the cargo being handled.

In one or more embodiments of the invention, the portal cache system includes environmental controls such as temperature and/or humidity management within each bay, making it suitable for sensitive materials that require regulated conditions. This enables the portal cache system to store pharmaceuticals and perishable commodities, and highlights its potential utility in complex logistics environments like airports or cross-docking facilities.

In one or more embodiments of the invention, the portal is designed to facilitate the automated handling and storage of pods. This includes mechanisms for both the entry and exit of pods to and from the pipe network, and for the temporary storage of pods within the portal area.

In one or more embodiments of the invention, the portal includes an automated pod gantry system configured to lift and move pods. The gantry consists of a motorized gantry crane equipped with a gripping mechanism that securely attaches to the pods. The gantry is configured to traverse along a set of rails or a track system that allows for horizontal and vertical movement. When a pod arrives at the portal, the gantry system activates and aligns itself over the pod. The gripping mechanism then lowers, attaches to the pod, lifts it from the pipe segment, and transports it through an exit door to the designated area within the portal or directly into the service bay for maintenance or loading/unloading of payloads.

In one or more embodiments of the invention, the portal is equipped with a pod cache system, which provides temporary storage for the pods. The pod cache locations within the portal are designed as modular slots or bays where pods can be parked and held securely. These cache locations serve various purposes, such as storing pods that are awaiting their next operation cycle, holding pods for scheduled maintenance, or temporarily housing pods until their payloads are ready to be loaded or unloaded. The design of the pod cache is such that it maximizes the use of space within the portal while allowing easy access for the automated gantry system to move pods in and out as needed.

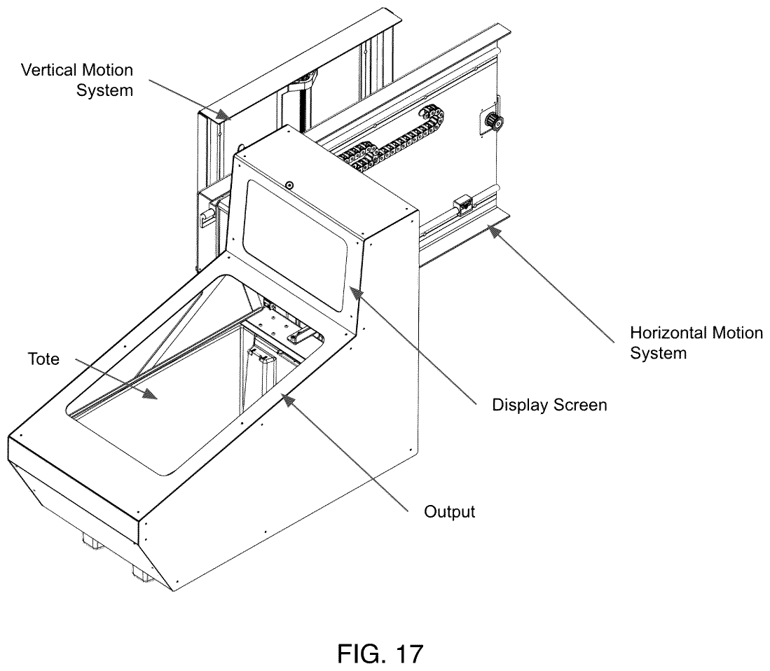

FIG. 17 depicts an example of an input/output system configurable for installation in a portal or terminal location, in accordance with various embodiments of the invention. As shown in FIG. 17, the input/output terminal includes an output area, a display screen, a horizontal motion system, and a vertical motion system. Thus, the input/output system can be configured to transport pods from below-ground or above-ground locations, including cache and storage locations in an automated manner.

### Portal Scanner

In one or more embodiments of the invention, the portal is equipped with advanced scanning capabilities designed to ensure the security and integrity of the contents within each removable tote. The portal may be structured to incorporate multiple scanning technologies, including visual cameras, X-ray machines, infrared sensors, and chemical sniffers. These technologies are strategically embedded within the portal's framework to provide a thorough analysis of the tote's contents as it passes through the scanning zone. Visual cameras offer high-resolution imaging to inspect the exterior condition of the tote and detect any external tampering or damage. In one embodiment, an integrated X-ray scanner provides a deeper look into the contents, identifying objects within the tote that are not visible externally. In one embodiment, infrared sensors are used to detect heat signatures that might indicate electronic devices or other heat-emitting materials concealed within the cargo. In yet another embodiment, a chemical sniffer module is configured to detect a wide range of substances, from explosives to hazardous chemicals, ensuring that no dangerous materials are transported through the system.

In one or more embodiments of the invention, each scanning module within the portal is equipped with one or more sensors that work in concert to perform a comprehensive scan. These sensors may be integrated into the portal's structure, with data feeds converging into a central processing unit. This unit analyzes the incoming data streams in real-time, using advanced algorithms to quickly identify potential threats or contraband. In one or more embodiments of the invention, all scans or some portion of potentially suspicious scans are sent to the logistics server for further analysis. In response to the logistics server commands, any failed scans may result in the removable tote or even the entire pod containing the tote to be quarantined or stored in a cache location until it can be removed or otherwise processed.

In one or more embodiments of the invention, to facilitate an uninterrupted and thorough scanning process, the portal includes mechanisms for the automatic opening of a payload bay of the removable tote. This feature allows the internal scanning apparatus to access the contents without manual intervention, enhancing both the speed and safety of the operation. In one or more embodiments, in scenarios where opening the payload bay might pose a risk or disrupt the integrity of the cargo, alternative methods are employed where sensors extend into the bay while maintaining the tote's closure. This scanning approach ensures that various types of cargo can be accommodated and securely scanned without compromising the structural integrity of the payload or the speed of the delivery process.

An example of the scanning process in operation begins when a pod approaches the portal. As the pod enters the scanning zone, the integrated sensors automatically initiate a sequential scanning protocol. First, visual cameras capture detailed images of the tote's exterior for any signs of tampering or damage. Simultaneously, X-ray and infrared scans are conducted to assess the contents and heat signatures within the tote. Chemical sniffers analyze the air around and inside the tote for any trace of prohibited substances. If a potential threat is detected, such as a bomb or hazardous chemical, the system alerts security personnel while initiating safety protocols to isolate the pod and prevent further transit through the network. If the tote is cleared, the automatic doors of the payload bay reseal, and the pod is allowed to continue to its destination.

### Portal+Junction Design

In one or more embodiments of the invention, the pipe delivery system features a combined portal and junction design. This integrated structure allows for the transfer of pods between different pipe segments, as well as comprehensive tote/pod management features of a standard portal including tote swapping, payload delivery, and tote/pod caching.

In one or more embodiments of the invention, the combined portal and junction design incorporates a mechanical and control system that manages the directional flow and sorting of pods as they transition between pipe segments. In one embodiment, the combined portal includes a turntable mechanism in the pod landing area at the level of the pipe network, which can rotate to align with multiple pipe entries and exits, depending on the intended direction of the pod's travel. The landing area is also the point at which pods stop in order to swap/load removable totes using the tote lift mechanism. The turntable is motorized and controlled by a central control module that receives destination data from the pods and/or logistics server via wireless communication. For example, when a pod approaches the junction, it may send a signal indicating its next route triggering the turntable to align itself accordingly, facilitating a seamless transfer to the next segment without the need for the pod to stop or significantly reduce speed.

### Portal/Junction Housing

In one or more embodiments of the invention, the body of the portals and/or junctions are constructed from a repurposed drain basin. In one embodiment, a drain basin may be an off-the-shelf component used for drainage applications and may be repurposed for use as a structural member of the portal and junction design. The drain basin is constructed as a large vertical tube equipped with a cover (e.g., a manhole cover), designed to provide access for maintenance and system upgrades. Positioned vertically as a body component of each portal and junction, the basin is directly connected to a pipe segment of the pipe network through robust pipe connection flanges.

In one or more embodiments of the invention, beneath the pipe segment within the drain basin, a void space is engineered to house various critical components. This area may include power supplies and battery storage units, communication devices, and/or charging systems, in accordance with various embodiments. By positioning these components in the void space of the drain basin, the system optimizes for maintenance while minimizing the spatial footprint of the portal or junction. The void space in the drain basin can be designed with modular slots, allowing for quick and easy swapping of components such as batteries and communication modules. This modularity supports rapid adaptation to evolving technological needs and simplifies maintenance operations.

In one or more embodiments of the invention, the interior walls of the drain basin are utilized to affix the linear guide rails of the tote lift system. This placement allows the guide rails to extend vertically, facilitating the seamless transfer of removable totes into and out of the pods. When a pod arrives at a portal or junction, it aligns with these guide rails; the totes are then either lifted from the pod into the storage system or lowered into the pod for delivery. This setup not only streamlines the loading and unloading process but also enhances the speed and efficiency of cargo handling at portal locations.

In one or more embodiments of the invention, sensors are installed within the basin to monitor the condition of stored components, detect water ingress, and assess structural integrity. The logistics server can read these sensors to trigger alerts for preventive maintenance.

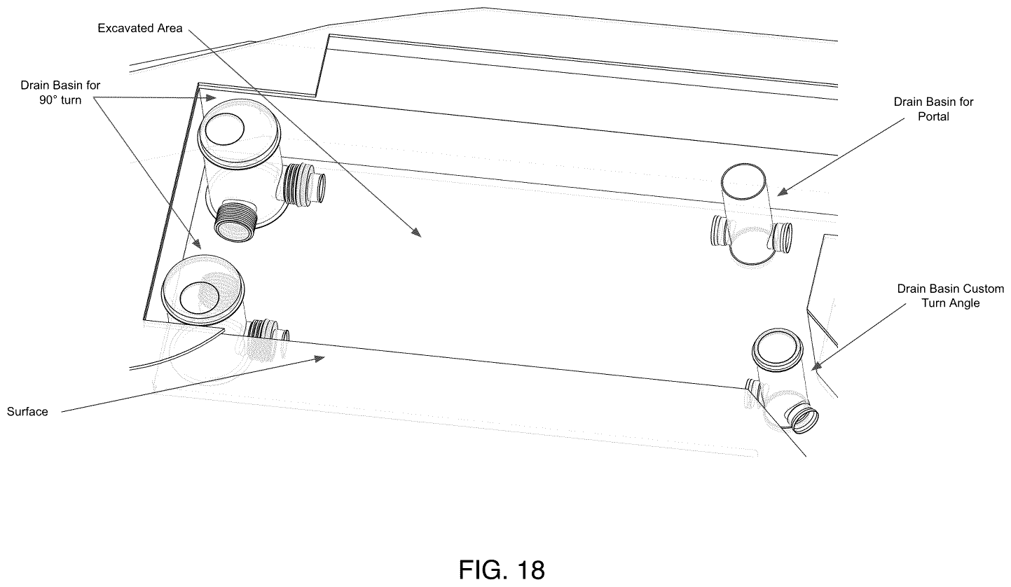

FIG. 18 depicts an isometric view of multiple drain basins in an excavated area of a pipe network, in accordance with various embodiments of the invention. The example of FIG. 18 includes two drain basins for 90 degree turn junctions, a drain basin for a portal, and a drain basin with a custom turn angle. Any number of other layouts are possible, in accordance with various embodiments.

### Network Transition Tech

In one or more embodiments of the invention, network transition technology is employed to efficiently manage the entry and exit of totes and packages to and from the pipe delivery system. This technology ensures seamless transition between different delivery modes, such as from delivery vehicles like robots or drones to the pipe delivery system, and vice versa.

In one or more embodiments of the invention, the system facilitates interactions between automated machinery and human operators at various terminal locations. These interfaces are designed to accommodate both the insertion and retrieval of totes which contain individual packages. In some embodiments, the interfaces include robotic arms and drones equipped with precision handling tools to engage totes directly or deposit them back into portals or terminal cache locations after transit. In some embodiments, for manual operations, the interfaces include tote/package conveyors and sliding rails that align with the storage areas of the totes.

In one or more embodiments of the invention, external package handling facilities are integrated into the system. These facilities function as intermediary sorting and staging areas where totes are prepared for insertion into or removal from the delivery pods. Such facilities might utilize conveyor systems, automated sorting algorithms, and robotic handlers designed to streamline the process of package handling before and after pod transport. Robotic systems at terminal locations and external facilities may be configured to automatically load and unload totes to and from the pods and/or portals which then transport to and from pods. These robots are equipped with sensors and actuators that allow them to handle various tote sizes and shapes with high precision.

In one or more embodiments of the invention, drones are used for overhead transfer of totes and packages. These drones are equipped with clamping mechanisms that securely latch onto the totes in a designated area, and subsequently deliver them to and from various external destinations.

### Network Communication

In one or more embodiments of the invention, the pipe delivery system incorporates a network communication system that may include several optional components to facilitate the operation and management of pods within the network. These components are designed to ensure seamless coordination across the delivery system but are not all required in every implementation.

In one or more embodiments of the invention, the pipe delivery system includes one or more network beacons positioned in proximity to the pipe network at various locations. These devices are strategically placed throughout the pipe network to serve as navigation aids and to communicate, either bidirectionally or unidirectionally (depending on the chosen implementation), with pods traversing the network. A network beacon can emit signals that can be detected by passing pods, providing them with precise positional data and operational commands. In one embodiment of the invention, the beacons include an ultra-wideband (UWB) component for signal transmission, which offers the advantage of high accuracy and minimal interference. The beacons are housed in robust, weather-resistant enclosures specific to environmental constraints and requirements of the system. In another embodiment, beacons incorporate Bluetooth Low Energy (BLE) or Near-Field Communication (NFC) technology to communicate with nearby pods, providing them with necessary navigation data and operational commands.

### Portal Communication

In one or more embodiments of the invention, communication devices are integrated within the portals of the pipe delivery system. In one embodiment, the beacon is an ultra-wideband (UWB) device structured to include a transmitter that sends high-bandwidth radio waves. In one embodiment, the UWB devices send longer range communication with a low-energy profile, and enable faster read times. The UWB-enabled beacon broadcasts an active, unidirectional signal outward in all directions from the device location. This enables the pods to read (but not respond) location, range, traffic, and other information from the beacon as they approach the portal from any direction. In one or more embodiments of the invention, pods are capable of determining the location of the beacon as they enter and exit the portals through time-of-flight measurement techniques, which calculate the time it takes for a radio wave to travel from the transmitter to the pod receiver.

An example of this functionality is when a beacon sends a signal to a pod to adjust its speed due to upcoming traffic conditions or diversions within the network. The beacon sends periodic signals that are received by the passing pods, ensuring they are constantly updated with real-time network conditions.

### Pod-to-Pod Communication

In one or more embodiments of the invention, one or more pods include functionality to engage in pod-to-pod communication. This allows pods to directly exchange information, such as speed and cargo status, which helps them to navigate the network more efficiently and avoid conflicts. In one example, the communication is based on a mesh network topology using the MQTT protocol to ensure rapid, reliable message delivery. Security measures such as AES-256 encryption may be employed to protect the data exchanged between pods.

For example, pods within the network communicate with each other using dedicated BLE modules that support mesh networking protocols. This inter-pod communication allows pods to relay information about their position, speed, and operational status, enabling them to operate as a coordinated fleet.

For example, if a leading pod identifies an obstacle or a delay in its path, it can immediately relay this information back to following pods, which can then adjust their routes or speeds accordingly. This communication occurs continuously, with data packets being exchanged every few milliseconds to ensure all pods are synchronized.

In one or more embodiments of the invention, each pod in the delivery system is equipped with an RFID tag. These tags serve as mobile identifiers that can be read by beacons, destination terminals, or other communication devices embedded within the system, facilitating various functions such as routing and/or maintenance. RFID is used for example purposes, while other identification mechanisms can be utilized in various embodiments of the invention. In one example, the RFID tags on the pods are integrated into the exterior shell of each pod in a manner that maximizes their readability from various angles. These tags are encoded with data specific to the pod, such as its identity, destination, cargo contents (e.g., type of cargo, and/or dynamically updated payload information programmed at the pickup portal), and operational status. In this example, as a pod enters a portal, the RFID reader located within the portal's structure scans the pod's tag. The information retrieved could dictate several actions: directing the pod to a specific cache location within the portal based on its cargo type or ensuring the correct tote is loaded or unloaded in synchronization with the portal's tote lift mechanism.

In one or more embodiments of the invention, pod RFID tags are not only read by but also written to by the system's RFID writers located at critical points, such as maintenance/destination terminals or junctions. These writable RFID tags could receive updates about system changes, new routing instructions, or even software patches, which are then stored on the pod's onboard computer system. This functionality would allow for an adaptable and responsive network where pods are updated with the latest system data in real-time.

The system might employ a variety of communication technologies, each selected based on its suitability for specific tasks within the network. For example, RFID could be used for short-range identification tasks at terminals, while 5G cellular might be preferred for precise, real-time tracking of pods within the pipes. Wi-Fi could also be used where high data throughput is necessary, such as at major network hubs or terminals. Each of these technologies offers different benefits and constraints, such as range, data rate, and resistance to environmental interference, allowing the system to be tailored to the specific operational needs of different sections of the network.

In one or more embodiments of the invention, the pipe delivery system includes a modular design. This flexible approach to the design of the network communication system ensures that the pipe delivery system can be customized to meet varying operational demands while maintaining the potential for upgrades and integration of emerging technologies. This adaptability is crucial for optimizing performance and cost-effectiveness across different implementations of the system.

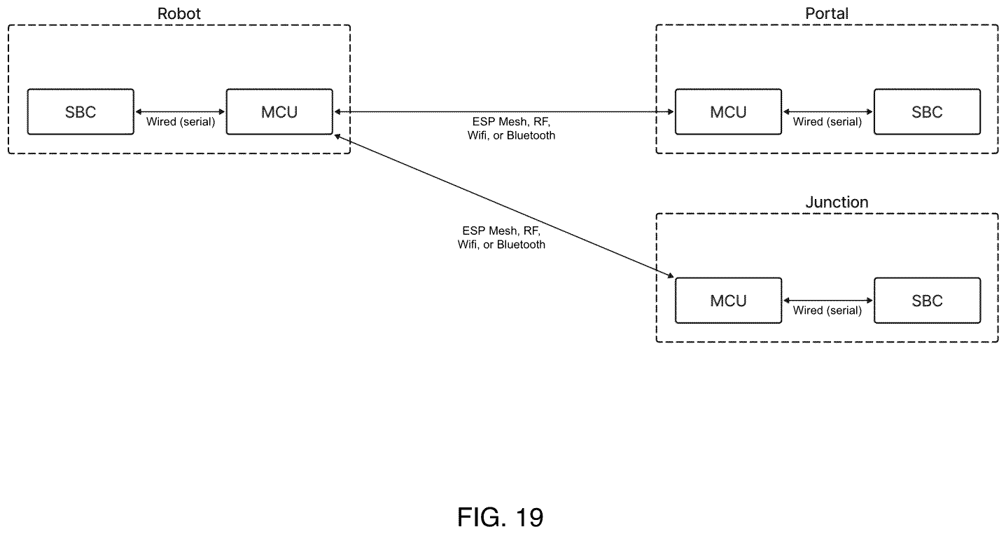

FIG. 19 depicts a first example of a communication architecture, in accordance with various embodiments. In the example of FIG. 19, the pod includes a wired serial connection from the microcontroller unit (MCU) unit to the single-board computer (SBC). In this example, pods are configured to communicate bi-directionally with portal, junction, and/or terminal locations via ESP mesh, radio-frequency (RF), Wifi, and/or Bluetooth.

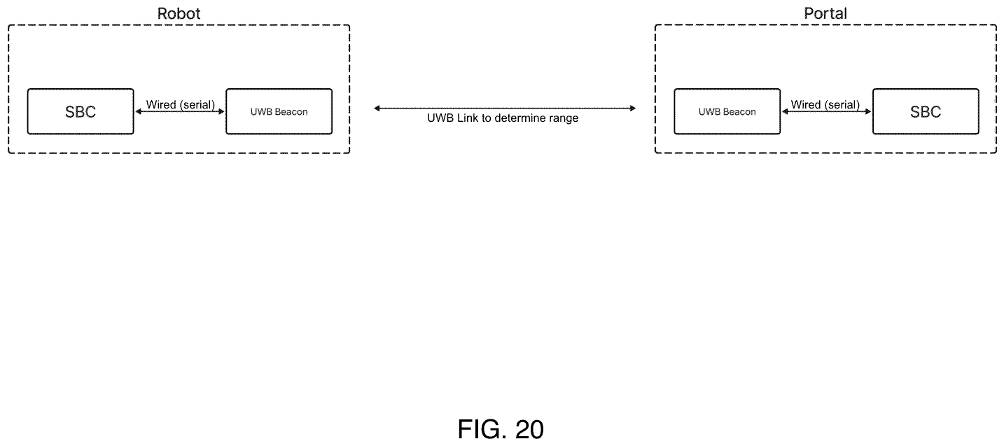

FIG. 20 depicts a second example of a communication architecture, in accordance with various embodiments. In the example of FIG. 20, both the pod and portal include a wired serial connection from the UWB beacon to the single-board computer (SBC). In this example, the UWB beacon broadcasts a unidirectional signal which is then read by the recipient and used to determine range of the pod to the portal location.

### Pod

In one or more embodiments of the invention, the pipe delivery system includes one or more pods designed to transport goods through the pipe network. Pods can include multiple components, including but not limited to, cargo modules, drive modules, pod body/frame, sensor expansion areas, and passive wheel modules.

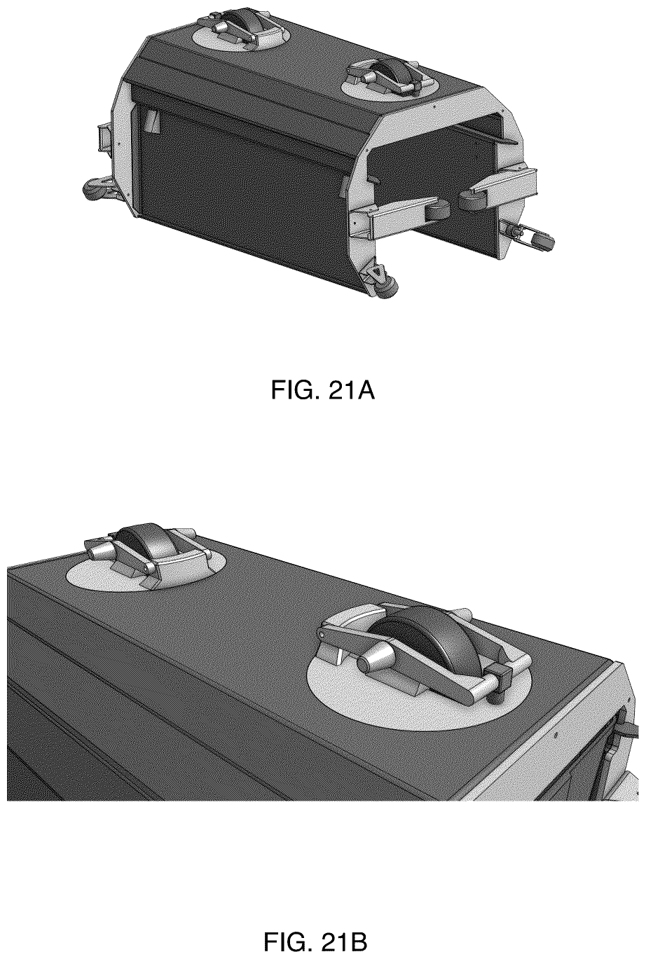

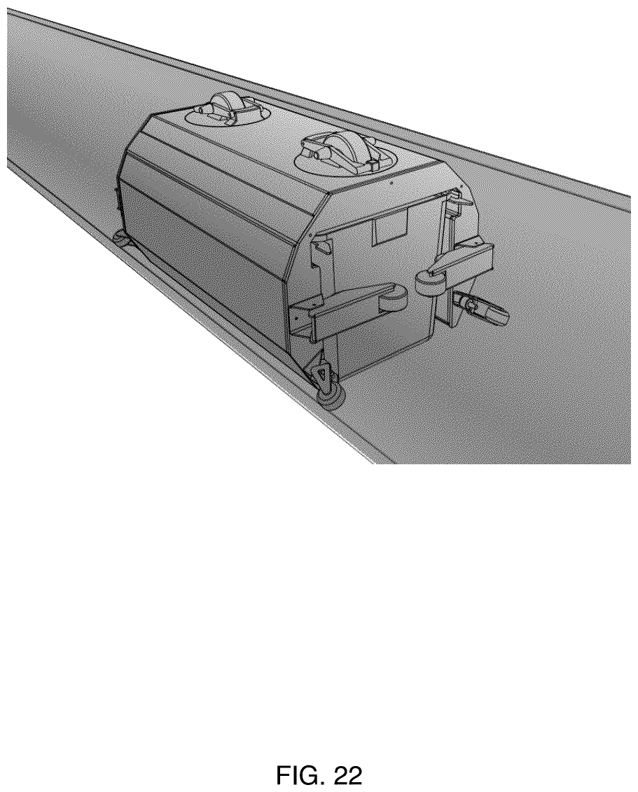

FIGS. 21A and 21B depict isometric designs of a pod including a gate assembly and configured to traverse a guide rail positioned above the pod. This design is just one among many potential configurations, including but not limited to, a lower guide rail positioned below the pod, a mechanism for vertical depositing and removal of the totes (rather than horizontal), and many more in accordance with various embodiments of the invention. FIG. 22 includes an exemplary illustration of the pod traversing a pipe segment, in accordance with one embodiment of the invention.

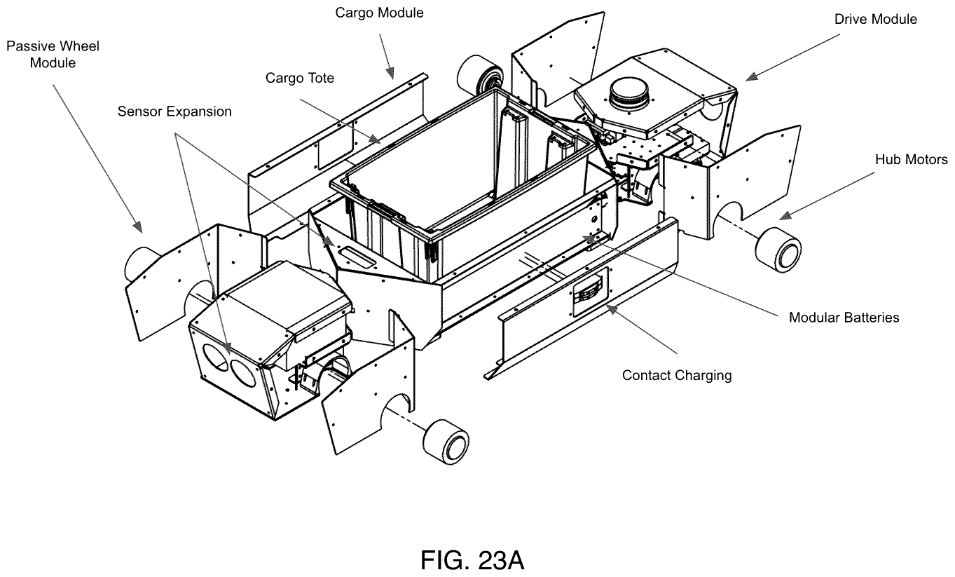

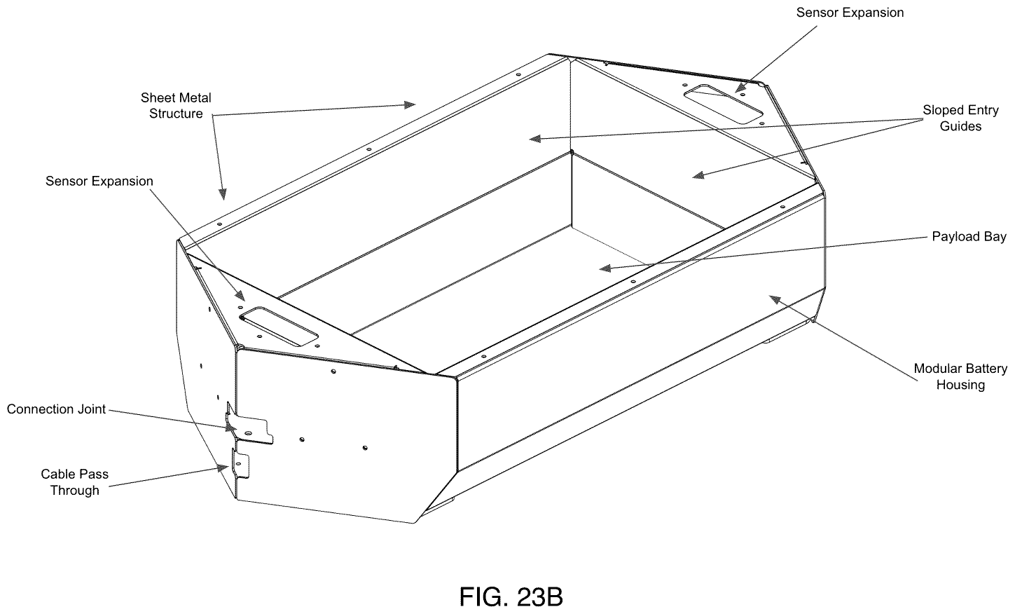

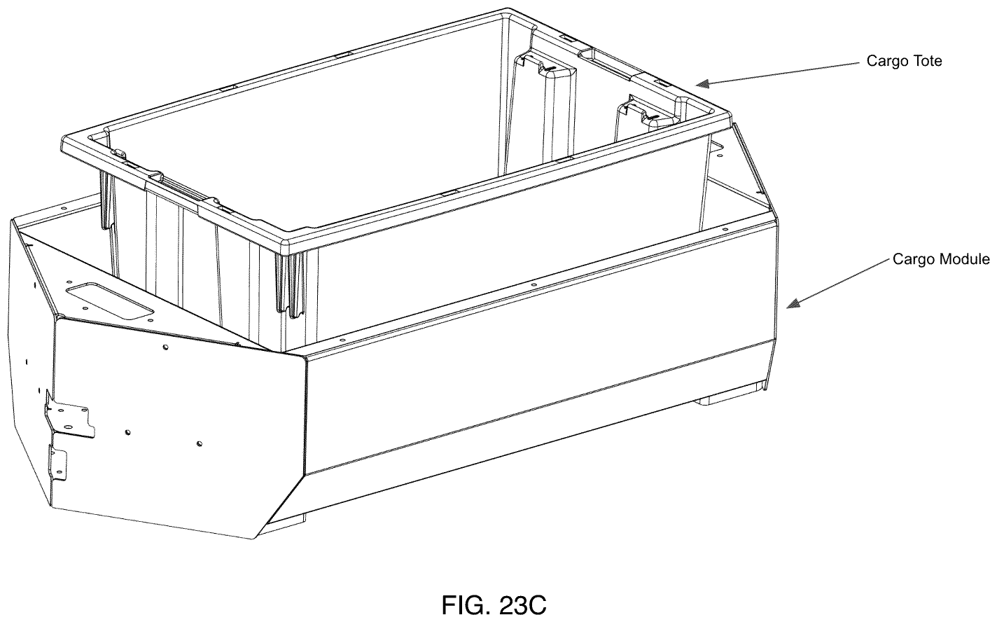

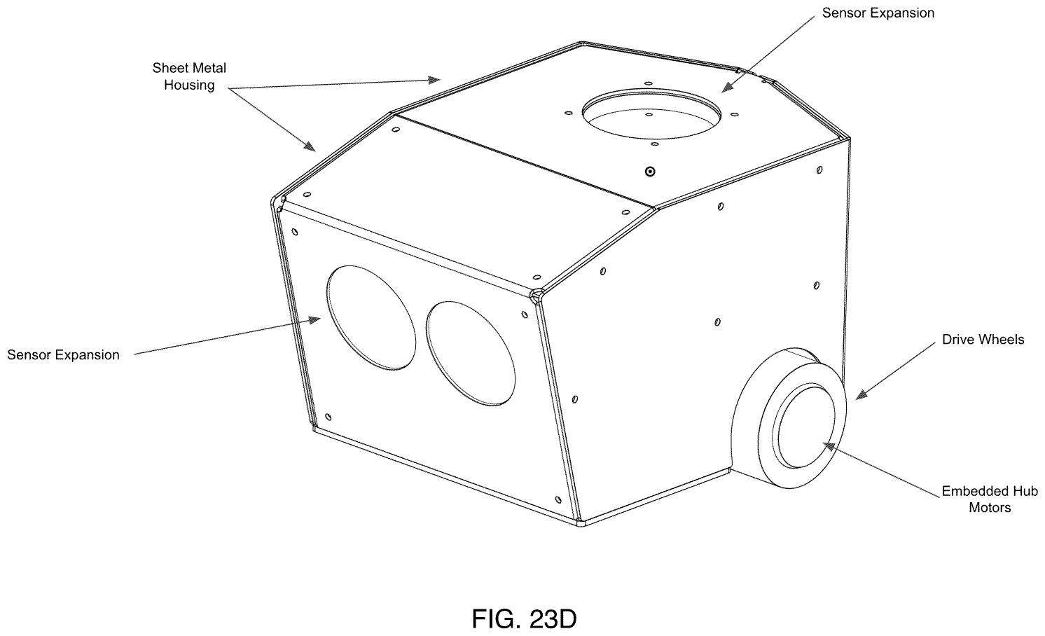

FIGS. 23A-23D depict various isometric views of a pod and its components in accordance with one or more embodiments. As shown in FIGS. 23A-23D, the pod has multiple components including a cargo module, a removable tote, sensor expansion areas, a drive module, a passive wheel module, hub motors, modular batteries, and a contact charger. Those skilled in the art will appreciate that there can be more than one of each separate component in a pod, as well as any combination or configuration of these components within a given embodiment or design.

### Cargo Module

In one or more embodiments of the invention, the pod cargo module is configured to securely hold a removable tote, which facilitates the transport of various goods. In one example, the cargo module is rectangular and constructed from lightweight, durable materials such as reinforced composites or aluminum alloys to withstand the dynamic pressures of transit. The interior of the cargo module may be lined with cushioning material to protect the contents during movement. In one embodiment of the invention, the cargo module is equipped with a locking mechanism that ensures the tote remains securely fastened during transit, even when navigating through high-speed turns or sudden stops.

In one or more embodiments of the invention, the pod cargo module includes a contact charger. The contact charger may be integrated into the base of the cargo module, allowing for automated charging whenever the pod is docked at a portal equipped with a compatible charging interface. In one embodiment of the invention, the system uses conductive charging technology, where electrical contacts of the contact charger align with contacts on the charging station to facilitate energy transfer.

In one or more embodiments of the invention, the cargo module facilitates bi-directional loading and unloading, allowing access to the removable tote from both the front and back of the pods. This design may reduce turnaround times at portal locations and improve the versatility of pod deployment in constrained spaces. Mechanisms such as sliding or pivoting doors, which are operable via remote control and/or automated systems linked to the pod's control module, enable this dual-access functionality.

In one or more embodiments of the invention, the cargo module utilizes an integrated system of electromagnetic and permanent magnets for removal and securement of the removable tote within the cargo module. In one embodiment of the invention, permanent magnets embedded in the cargo module's framework and the tote itself provide a strong, maintenance-free hold during transit. In another embodiment, electromagnets enable the flexibility needed for rapid engagement and release during loading and unloading procedures. This setup ensures that totes can be quickly and safely attached or detached with minimal manual intervention.

In one or more embodiments of the invention, the cargo module's aerodynamic design supports both active and passive aerodynamics to optimize energy use and enhance speed capabilities. The module's shape is streamlined to reduce aerodynamic drag, which is particularly beneficial when operating in pneumatic or vacuum-assisted delivery systems.

In one or more embodiments of the invention, to protect delicate cargo from the impacts and vibrations of transit, the module is equipped with shock absorbers and/or gyroscopic stabilizers. These components may enable maintaining cargo integrity, particularly in high-speed or rugged operational conditions. In one or more embodiments, the control module includes functionality to dynamically adjust these stabilizers to compensate for motion and vibration, based on real-time telemetry data from the pod's onboard sensors.

In one or more embodiments of the invention, the removable tote features a built-in battery pack located at its base, which facilitates automatic charging when the tote is docked within the cargo module at terminal stations. This system may enable pods to operate continuously, without the need to stop for charging. Furthermore, in one embodiment, any integrated electronics or temperature controls within the pod or the tote are maintained without requiring external power sources. In one or more embodiments, the cargo module is fitted with various sensors that monitor environmental conditions and cargo security, providing data to the pod's control module for ongoing assessment and management.

In one or more embodiments of the invention, to prevent cargo from shifting during transport, especially in high-speed or variable-direction scenarios, the module includes an expandable air bladder or a flexible membrane attached to a linear actuator. These components may expand or contract to fill void spaces within the cargo hold, securing the cargo dynamically. The rigidity and positioning of these containment systems are controlled by the pod's control module, which adjusts settings based on speed and directional changes to maintain cargo stability.

In one or more embodiments of the invention, a security system is integrated into the cargo module to prevent and respond to tampering. If unauthorized access is detected, the system can deploy non-lethal deterrents such as marking powder, emit distress signals, and initiate lockdown procedures. The module can also be customized to hold specific types of totes—such as refrigerated, chemically resistant, or padded—tailored to the requirements of diverse cargo types like food, medical supplies, or hazardous materials. These specialized totes include appropriate environmental controls and materials to ensure cargo safety.

In one or more embodiments of the invention, the control module regulates the speed of the pod based on the type of cargo being transported. Speed limits are programmatically set and adjusted, by the control module, to accommodate the safety requirements of sensitive or high-risk materials, ensuring compliance with regulatory standards and minimizing the risk of accidents.

FIGS. 23B and 23C depict isometric views of a cargo module in and its components in accordance with one or more embodiments. As shown in FIGS. 23B and 23C, the cargo module has multiple components including a sheet metal structure, sensory expansion areas, a payload bay configured to hold a removable tote, sloped entry guides configured to guide the tote into the payload bay and avoid/correct misalignment, a modular battery housing, a cable passthrough, and a connection joint for assembly into the pod body.

### Drive Unit

In one or more embodiments of the invention, pods within the system are engineered with drive and/or passive wheel assemblies for propulsion and stabilization. The drive module, powered by an electric motor, can generate sufficient torque to move the pod at speeds optimizing for time efficiency and energy use, such as maintaining a target velocity (e.g., 60 km/h) in populated urban areas to ensure timely delivery. The drive module may include an electric motor and/or embedded hub motors located in the wheels. Hub motors allow for compact design and direct power transmission, enhancing the pod's energy efficiency. In one or more embodiments of the invention, the hub motors are operatively connected to a controller and a battery bank. In this way, the hub motor includes functionality to perform regenerative braking, contributing to the charging of the pod's batteries during deceleration.

In one or more embodiments of the invention, the passive wheel assembly is designed to support the weight of the pod and its cargo without contributing to propulsion. These wheels may be equipped with high-durability rubber tires and/or shock-absorbing suspensions to reduce vibration and improve the stability of the pod during transit. In one example, the suspension system is configured to adjust dynamically to the load of the pod, maintaining stability across various cargo weights.

FIG. 23D depicts an isometric view of a drive module in and its components in accordance with one or more embodiments. As shown in FIG. 23D, the drive module has multiple components including a sheet metal housing, sensor expansion areas, drive wheels, and embedded hub motors. Examples of sensory devices embedded into the drive unit include, but are not limited to, an odometry sensor, an accelerometer, a gyroscope, a speed sensor, a temperature sensor, a proximity sensor, a vibration sensor, and more.

### Pod Battery Module

In one or more embodiments of the invention, the pod includes a battery module including a battery pack for powering the pod's electronic systems and propulsion. The battery module in the pod serves as the primary power supply and may, in one embodiment, be located at the base of the cargo module to optimize weight distribution and stability. In one example, the module is designed to contain a high-capacity lithium-ion battery pack that provides the electrical energy required for all pod operations, including propulsion, sensor operation, and communication systems. In this example, the battery housing is constructed from a fire-resistant composite material and is sealed to prevent moisture ingress, ensuring safe operation in varying environmental conditions within the pipe network. It includes thermal management systems, such as cooling fans and heat sinks, to maintain optimal operating temperatures and prevent thermal runaway.

In one or more embodiments of the invention, the battery module is integrated within the passive wheel assembly of the pod. This placement utilizes the space within the wheel assembly, which typically does not include active mechanical components like motors, thereby efficiently using the available space. The battery supplies power to the active wheel assembly and other electronic components of the pod, such as sensors and control modules. Technically, this configuration involves connecting the battery module's output to the pod's power management system.

Various embodiments of the invention may utilize a variety of battery types, including potentially power sources other than batteries. For purposes of this disclosure, the term “battery module” may refer to any power source utilized by any given embodiment. For example, the battery could be a lithium polymer type known for its good energy density, or it could be a supercapacitor which allows for rapid charging and discharging cycles, beneficial for short, high-energy bursts during acceleration or uphill traversal in the pipe network.

In one or more embodiments of the invention, the battery module is integrated within the removable tote. This configuration allows for the battery to be swapped by simply replacing the tote, facilitating quick changes of the power source at designated swapping stations or portals without significant downtime for the pod itself. In this configuration, electrical connectors at the base of the tote engage with corresponding connectors in the cargo module of the pod when the tote is loaded. This setup enables the battery within the tote to power the pod's systems as soon as it is docked. The connectors might be designed to support both electrical power transfer and data communication, allowing the tote's battery status and health to be monitored continuously.

In one or more embodiments of the invention, the battery module is designed to be swapped independently of the tote. This approach is beneficial in scenarios where the battery's discharge rate is faster than the tote exchange rate, or where battery maintenance needs to differ from tote usage patterns. The independent swapping mechanism involves a standardized battery form factor that can be automatically or manually exchanged at battery swapping stations integrated within the network's portals or maintenance basins.

In one or more embodiments of the invention, the battery module is charged in transit using inductive coils placed around the pipe segments. This method ensures continuous operation without the need for stopping at dedicated charging stations. The pipe segments are equipped with embedded inductive charging coils that create a magnetic field, which induces an electrical current in a receiver coil located within the pod, thereby charging the battery as the pod passes over these segments. This system requires integration of the inductive coils in the pipe infrastructure and the pod's design to align the coils properly for efficient energy transfer. The use of supercapacitors in the pod could optionally complement this setup, as they can quickly absorb the energy from brief exposures to the inductive fields in the pipes.

In one or more embodiments of the invention, the power supply system of the pod, including the battery module, may be entirely decoupled from the payload system, i.e., the removable tote. This decoupling allows for the battery system to be optimized solely based on the propulsion needs without being constrained by the tote's design or its own power requirements. Such a configuration would entail a dedicated battery compartment within the pod's chassis, separate from the cargo module. This allows for more flexibility in battery size, type, and the integration of advanced cooling or heating systems to maintain optimal battery performance across varying environmental conditions encountered within the pipe network.

The various embodiments of the battery module provide a range of options that can be tailored to specific operational requirements, including rapid charging capabilities, modular swapability, and continuous charging via inductive coils. These options offer the flexibility needed to optimize the delivery system for different scales of operation, from small-scale local systems to extensive industrial applications, ensuring that the system can adapt to various different use cases.

### Pod Suspension

In one or more embodiments of the invention, the pod is equipped with an integrated suspension system. The suspension system may be designed to minimize vibration, stabilize cargo, and/or adapt to a wider range of pipe segment configurations such as variable diameter pipes. The suspension system of the pod may include various types of suspension mechanisms, such as air suspension, spring-based suspension, and liquid-filled dampers. Each type serves to absorb and mitigate the impact of irregularities within the pipe segments, such as bumps or changes in pipe diameter, that the pod may encounter during transit.

In one or more embodiments of the invention, the pod includes an air suspension system utilizing air bags that inflate or deflate to adjust the firmness of the ride. In one embodiment, the control module is configured to adjust the suspension dynamically based on the cargo weight and the speed of the pod, which can vary significantly between different segments of the delivery route. For instance, a heavier cargo load or higher transit speeds might necessitate a stiffer suspension setting to prevent undue cargo movement and ensure stability.

In one or more embodiments of the invention, the pod includes a spring-based suspension system, involving the use of metal springs. This provides a cost-effective and simple method for absorbing impacts. The springs compress and expand to counteract the forces of bumps and jolts, thereby protecting the structural integrity of the pod as well as the safety of the cargo.

In one or more embodiments of the invention, the pod includes a liquid-based suspension system. Liquid-filled dampers, or hydraulic suspension systems, enable precision damping by using a fluid to absorb vibrations. The viscosity of the liquid within these dampers can be adjusted according to environmental conditions or specific requirements of the cargo, such as the need for a smoother ride for fragile items. In one embodiment of the invention, the control module is configured to dynamically adjust the viscosity of the liquid using an electrical mechanism designed to interact with the chemical structure of the liquid.

In one or more embodiments of the invention, the pod is equipped with custom tires designed to minimize vibrations and noise, contributing to a smoother and quieter operation. These tires may be made from advanced composites that combine flexibility and durability, capable of withstanding the unique environmental conditions within the pipe, such as changes in temperature and exposure to moisture. In one embodiment, the control module is operatively connected to an onboard air compressor and is configured to dynamically adjust air pressure of the tires based on payload, terrain/pipe characteristics, environmental conditions, and other variables. The tire tread patterns and materials may be selected to optimize traction while minimizing the generation of vibrational noise. This choice ensures that the pod can maintain consistent contact with the guide rails or the inner surface of the pipe, essential for effective propulsion and braking.

In one or more embodiments of the invention, to accommodate variations in segments of the pipe network such as variable diameter pipes, the suspension system includes mechanisms that allow the pod to adjust its orientation and height within the pipe. This feature may enable the pod to travel through different sections of the network without the need for manual adjustments or modifications to the hardware. In one embodiment, this is achieved through the use of adjustable suspension arms that can extend or retract based on the detected pipe diameter. Sensors integrated into the pod's control system are configured to measure the diameter of the pipe segment in real time, and the suspension system adjusts accordingly to maintain optimal alignment and stability. This adaptive suspension capability may protect the cargo from shifts or spills during transit and/or preserve the integrity of the pod's operational components, thereby reducing maintenance needs and improving system reliability.

### Control Module

In one or more embodiments of the invention, the pod includes a control module configured to perform route calculation, communication, and orchestration of the pod's various components. Control modules within the pods may calculate routes using algorithms that process inputs like destination coordinates, current and anticipated traffic within the network, and environmental conditions, adjusting the pod's speed and path as needed. For instance, if a pod's intended route through a segment is obstructed, the system can reroute the pod through an alternative path, dynamically calculating the change to avoid delays.

In one or more embodiments of the invention, the control module is housed within a rugged, environmentally sealed enclosure that protects the electronic components from the conditions that may be found in industrial and urban delivery environments. It is positioned within the pod to balance the pod's weight distribution and to minimize the risk of damage from external impacts.

In one or more embodiments of the invention, the control module includes a central processing unit (CPU). The CPU is the brain of the control module, executing instructions from the pod's software to perform tasks such as route calculation, sensor data processing, and decision-making for autonomous operations. It processes all the inputs from the pod's various sensors and communication interfaces to output the necessary commands for navigation and operations.

In one or more embodiments of the invention, the control module includes a hard disk drive (HDD). The HDD stores all necessary operational software, maps, and data logs. It is used for both the retrieval of navigational data and the long-term storage of operational records, which may be utilized for system diagnostics, maintenance, and compliance with regulatory requirements. For example, the HDD may store extensive map data of the pipe network and historical traffic patterns, which the CPU accesses to plan routes. It also logs data such as travel times, sensor alerts, and maintenance records, which can be uploaded to the logistics server for further analysis.

In one or more embodiments of the invention, the control module includes a memory component. The memory component, typically RAM (Random Access Memory), provides the necessary workspace for the CPU to perform current processing tasks. It temporarily holds data that the CPU needs for quick access while performing operations, allowing for fast data retrieval and storage during active pod operations.

In one or more embodiments of the invention, the control module includes a control board. The control board integrates the various electronic components and interfaces of the control module. It includes circuitry that facilitates communication between the CPU, memory, HDD, and other peripheral devices such as sensors and communication modules. The control board also distributes power to these components and manages input/output operations.

In one example, the control module operates on a multi-core processor capable of real-time data processing and decision-making. It is equipped with multiple communication modules, including Wi-Fi, LTE, and ultra-wideband, to ensure continuous connectivity within the pipe delivery system. The control module's software includes advanced algorithms for dynamic route optimization based on real-time traffic data, energy management, and predictive maintenance analytics.

In one or more embodiments of the invention, the control module calculates the desired route using data from an onboard GPS and various sensors. Inputs to the route calculation system can include desired objectives such as energy-efficiency, delivery time, and more. The control module may include functionality to communicate with network beacons to receive traffic updates and adjusts the route dynamically to avoid delays or congestion. For example, if a sensor detects a potential obstacle or system fault ahead, the control module reroutes the pod to an alternative path, ensuring timely delivery without manual intervention.

### Pod Sensors

In one or more embodiments of the invention, the pod includes a variety of sensors configured to obtain information about the environment, condition of the pod, and general information relating to the pod's traversal of the pipe network. These sensors may be installed at various locations throughout the pod's structure, including one or more sensor expansion areas of various pod components. For example, both the drive module and the cargo module may be equipped with designated areas for sensor expansion. These areas allow for the integration of additional sensors, such as temperature monitors, humidity detectors, or security cameras, depending on the specific requirements of the cargo being transported. For example, a sensor expansion bay in the cargo module can be fitted with a thermal imaging camera to monitor the condition of perishable goods, ensuring they remain within required temperature ranges throughout transit.

Examples of pod sensors can include, but are not limited to:

Lidar Sensors: These sensors enable precise distance measurement and mapping of the surrounding environment, enabling collision avoidance and navigating through densely packed pipe networks.

Thermal Sensors: These sensors enable monitoring of the temperature of the cargo and the internal electronics. This may be important for transporting temperature-sensitive goods, ensuring that they remain within prescribed limits throughout transit.

Vibration Sensors: These sensors detect and analyze vibrations that could indicate maintenance needs or potential failures in the pod's mechanical systems.

Optical Cameras: These sensors provide visual monitoring inside and outside the pod. In one embodiment, these cameras support security protocols by ensuring that the cargo is undisturbed during transit and assist in navigating complex junctions within the pipe network.

Humidity Sensors: These sensors may be utilized for monitoring the atmospheric conditions within the cargo module, especially when transporting hygroscopic materials or electronic components susceptible to moisture.

Proximity Sensors: These sensors may be used to detect the presence of other pods, obstacles, or changes in the pipe infrastructure. This may help in maintaining safe operating distances and adjusting speed dynamically.

In one or more embodiments of the invention, an optical camera positioned at the front of the pod provides real-time video feedback to the control module, which uses image recognition algorithms to detect and interpret signs or signals within the pipe (such as speed limits or direction markers). Simultaneously, vibration sensors can detect irregularities in the wheel assembly's operation, prompting the logistics server to trigger preventive maintenance checks to avoid unexpected breakdowns.

### Pod Body Design/Aerodynamics

In one or more embodiments of the invention, the pod configured to travel through a pipe delivery system is optimized for aerodynamics to facilitate efficient airflow around its body. For example, one or more pods of the pipe delivery system may include a quasi-cylindrical body with a polygonal cross-section, optimized for aerodynamics within the pipe environment. The polygon shape, such as a hexagon, is to facilitate both passive and active aerodynamics, improving energy efficiency and reducing drag. The polygonal shape may allow for the strategic placement of wheels and enhances airflow around the pod, which enables maintaining stability and speed, particularly in pneumatic or vacuum-assisted delivery systems. In one or more embodiments of the invention, the pod incorporates a radially symmetric architecture with configurations such as six sides and three wheels, or eight sides and four wheels, which provided a balance between structural integrity and aerodynamic efficiency. The body design may incorporate features like smoothed edges and contoured surfaces that guide air smoothly around the pod. This design may reduce the pressure drag and skin friction drag that typically occur during high-speed transits.

In one or more embodiments of the invention, integrated into the body are air flow channels that serve to guide air smoothly around the pod. These channels may be positioned to optimize the boundary layer, control the airflow separation, and/or reduce the formation of vortices that can increase drag. For example, air flow channels might be molded into the sides and top of the pod, where they can most effectively manage the air passing over the pod's surfaces.

In one or more embodiments of the invention, the materials selected for the pod's exterior are chosen based on their ability to lower the drag coefficient. These materials typically have smooth, non-porous surfaces that help to reduce the frictional drag by allowing air to pass over the pod with minimal resistance. Materials such as polished aluminum or composite polymers with a high-gloss finish may be used. These materials not only contribute to aerodynamic efficiency but also withstand the environmental stresses encountered within the pipe system, such as variations in temperature and exposure to moisture.

In one or more embodiments of the invention, the pod incorporates specific structural features that enable the modulation of air pressure against the pipe's side walls as the pod moves through the pipe network. This may contribute to stabilizing the pod's trajectory and enhancing its adherence to the pipe surface, particularly during high-speed transits. In one embodiment, the pod includes an air intake system strategically positioned at the front and sides of the vehicle. This system is designed to capture air as the pod moves forward, channeling it into a compression chamber where the air pressure is increased. The compressed air is then directed laterally towards the sides of the pod through a series of vents or nozzles that are aligned parallel to the axis of travel. This design allows the pod to utilize the air pressure generated by its own motion to press itself more firmly against the side walls of the pipe. The vents are adjustable, allowing the pod's control module to modulate the amount of air pressure exerted based on the speed of the pod and the characteristics of the pipe segment it is traversing. For example, in wider sections of the pipe or during sharper curves, the pod might increase the pressure output to maintain stable contact with the walls, preventing slippage or loss of control.

FIG. 24 depicts a cross-sectional view of a pod traversing a pipe segment on a guide rail in accordance with one or more embodiments. As shown in FIG. 24, the pod includes multiple wheel assemblies designed to keep the pod aligned and on top of the guide rail including a set of drive wheels and a set of keep wheels on an axis substantially perpendicular to the drive wheels. This design further includes a clearance area within the guide rail for drive module structures.

### Pneumatic Propulsion System

In one or more embodiments of the invention, the pod is pneumatically powered, incorporating an “engine” designed to pull the pod by creating a vacuum in front of it. This pneumatic engine may be positioned at the front or rear of the pod and may operate by expelling air from the front to the rear through internal channels, thereby creating a low-pressure area ahead of the pod. The differential pressure between the front and the rear of the pod propels it forward.

In one or more embodiments of the invention, the pneumatic engine includes a series of fans or turbines that are capable of moving large volumes of air efficiently. These components are powered by the pod's onboard energy systems, which may include batteries or supercapacitors. The design of the body channels supports this propulsion method by ensuring that air can be directed from the front to the rear without causing turbulence or backflow, which could reduce efficiency. The integration of the pneumatic engine requires alignment of the air expulsion mechanisms with the air flow channels. These channels are typically built into the core structure of the pod's body and may have adjustable features that allow for the modulation of airflow, adapting to different operational needs, environmental conditions, and/or speed of the traversing pod. The channels ensure that air expelled by the engine is used effectively to generate propulsion, optimizing the use of energy and reducing operational costs.

### Pod Chaining

In one or more embodiments of the invention, the pod includes an electromagnetic connection system, akin to that used in locomotives. This system allows for multiple configurations, including but not limited to: a single drive unit connected to multiple payload-only pods, a maintenance pod connected to a damaged or disabled pod, multiple connected pods for reduction in drag forces, and many more. The electromagnetic connections are designed for quick attachment and detachment, facilitating flexible configurations depending on the delivery load and route efficiency. In one or more embodiments of the invention, any other mechanism for connecting pods may be used, including a mechanical latch, a magnetic latch, and/or any variation of an electro-magnetic latch.

### Specialized Pod Types

In one or more embodiments of the invention, the system includes one or more payload-only pods. These pods are designed exclusively for carrying goods and do not include a propulsion system. They rely on being linked to drive-capable pods for movement. This separation enhances the versatility of the pipe delivery system, as multiple payload pods can be combined with a single drive pod, optimizing transport efficiency for larger loads or consolidated delivery routes.

In one or more embodiments of the invention, the system includes one or more maintenance pods. Maintenance pods are equipped with tools and systems necessary for the transport, upkeep, and/or emergency repairs of other pods and infrastructure within the pipe network. They can autonomously navigate to service terminals and are capable of “hitching” other pods, either by pushing or pulling them to maintenance locations. In one or more embodiments of the invention, a maintenance pod is capable of intercepting pods with low charge and charging them without interruption of service (i.e., while the pods are en route). The logistics server may be configured to identify and locate pods which require a charge in order to complete their intended route, and to dispatch a maintenance pod to intercept and charge these pods to enable completion of their route(s). The maintenance pod may include a contact charging adapter (or a contactless charging adapter) enabling the maintenance pod to establish an electrical connection to charge the pod. Similarly, in the locomotive design whereby multiple pods are chained together, the maintenance pod may be configured to charge any number of the chained pods through the charging adapters connecting all of the chained pods. Each pod may include a charge controller configured to optimally charge its battery and to act as a pass through for current to other pods in the circuit of connected pods.

In one or more embodiments of the invention, the system includes one or more drive-only pods. These pods are equipped with propulsion systems and can operate independently or be connected to payload-only pods. The flexibility of being drive-capable allows these pods to function in a variety of operational roles, from direct delivery to acting as a tug for non-motorized pods, thus maintaining the flow of goods across the network. In one or more embodiments of the invention, the drive-only pod is low profile such that it is capable of detaching and traversing underneath other pod types, such as payload-only pods. For example, the drive-only pod may occupy a maximum of one-fourth of the interior height of the pipe, whereas the payload-only pod occupies a maximum of three-fourths of the interior height of the pipe. Maintaining orientation of the pods may be achieved by using a rail guide, keeping a balanced center-of-gravity by keeping appropriate weight distribution, or any combination thereof. For example, the wheels of the drive module may be oriented on bottom to affect lower center of gravity and keep the pod oriented upright.

### Example: Specialized Pod Types

In one example, a delivery task requires the transport of multiple types of goods, each with different destination timings and priorities. The logistics server calculates that combining three payload-only pods with one drive-capable pod is the most efficient configuration. The drive-capable pod uses its electromagnetic connection system to attach to three payload-only pods at the loading bay. The combined unit travels through the pipe network, using data from beacons and onboard sensors to dynamically adjust the route for optimal delivery time. Upon completing deliveries, the drive pod detaches from the payload pods and connects to a maintenance pod to transport it to a service station for scheduled upgrades.

In one or more embodiments of the invention, either the pod, the tote, or both pod and tote can be specialized for specific applications and/or payload. This may enable handling of a variety of cargo types including temperature-sensitive goods and hazardous materials, as well as the provision of in-transit services such as battery charging.

In one or more embodiments of the invention, the pod and/or tote design enables the transportation of temperature-sensitive goods. In embodiments where the tote is specialized, it is equipped with built-in insulation and refrigeration capabilities, allowing it to maintain required temperatures independently of the pod. This type of tote includes an integrated cooling system that can be powered through battery packs within the tote or through connections to the pod's power supply. Alternatively, in one or more embodiments, the entire pod is designed to create a refrigerated environment for the payload, with thermal insulation incorporated into the cargo module's walls and an advanced refrigeration system that controls the temperature throughout the internal space of the cargo module. This design may enable deliveries where multiple totes, regardless of their individual insulation capabilities, need to be kept at a controlled temperature.

In one or more embodiments of the invention, the pod and/or tote design enables waste delivery. Either the pod and/or the tote can be specialized to handle different types of waste securely and hygienically. In one embodiment, specialized totes for waste transit are made from materials resistant to chemicals and equipped with seals to prevent leaks and contain odors. These totes can be loaded into standard pods for transport. In another embodiment, the pod itself is adapted for waste handling by fitting it with a containment and sealing system that ensures that even standard totes can be transported without risk of contamination or spillage. This system includes reinforced, easy-clean cargo module interiors and automated lid-sealing mechanisms that activate when waste totes are loaded or unloaded.

In one or more embodiments of the invention, specialized charging pods are designed to traverse the pipe network in order to charge other pods while they are in transit to their intended destination, with minimal or no interruption of service. The charging pod may include a larger integrated battery bank, or a specialized tote that houses additional battery storage. In various embodiments, both the charging pod and the receiving pod include features for both conductive and/or inductive charging. In one embodiment, the charging pod includes one or more battery-charging totes equipped with substantial battery reserves and the necessary electronics to manage power distribution. This tote can be transported by a standard pod to locations where additional power supply is needed, effectively serving as a mobile charging station for other pods in the network.

In one or more embodiments of the invention, the pod is configured for dual-mode operation, where pods can switch between active and passive modes, e.g., depending on the network segment they are traversing. The pods may be equipped with a modular drive module that enables the switch between active and passive operational modes. In the active mode, each pod is self-propelled, using its onboard electric motor and active wheel assembly to navigate through the pipe network. This mode is particularly useful in low-speed areas where precise maneuvering and slower, more controlled speeds are necessary, such as in areas close to portals or through complex junctions. Conversely, in passive mode, the pods do not utilize their internal drive systems. Instead, they are propelled by a separate high-speed drive unit pod, which is specially designed to move multiple chained passive pods together through high-speed segments of the pipe network. These segments are typically straight or substantially straight, allowing for rapid transit between distant points without the need for individual pod motor engagement. The transition from active to passive mode may be facilitated by the disengagement of the motor from the active wheels, effectively reducing resistance and enabling the pod to be towed by the high-speed drive unit. For example, when switching to passive mode, the pod's control module may send a signal to deactivate the motor and secure the wheels in a neutral position, minimizing drag and preparing the pod to be coupled with the high-speed drive unit.

In a first example, a pod starts its journey in active mode to navigate through a dense urban delivery network where precise control and slower speeds are necessary. Upon exiting the urban area, the pod may approach a designated transition point where it switches to passive mode. Here, the pod's wheels lock in the neutral position, and it docks with a high-speed drive unit waiting on a parallel track. The drive unit then propels the pod and possibly others linked in sequence through a high-speed rural segment to another urban area, where the pods disengage and revert to active mode for final delivery maneuvers.

In one or more embodiments of the invention, the system includes one or more sensor pods. Sensor pods are equipped with sensory components essential for assessing the condition of the pipe infrastructure. The sensor pods may be configured to navigate through pipe segments while continuously monitoring and recording various structural and environmental parameters. The sensor pod may include 3-dimensional cameras and sensor devices configured to scan the walls of the pipe network, their surrounding material, and components such as portals, junctions, and terminals. These devices may be used to create high-resolution images and models of the interior surfaces of the pipes and may include functionality to identify cracks, erosions, and/or any build-up that might compromise the pipe's integrity. In one or more embodiments, the sensor pod may include moisture sensors and/or Lidar configured to detect changes in humidity levels and the presence of unwanted liquid accumulations inside the pipe. Lidar technology provides precise measurements of the pipe's dimensions and detects subtle shifts or deformations that might indicate potential failures. In one or more embodiments, the sensor pod may include in-ground GPR (Ground Penetrating Radar) capable of detecting underground anomalies such as voids, subsidence, or unusually high moisture content that could affect the stability and integrity of the pipe network.

In one or more embodiments of the invention, the system includes one or more cleaning pods. Cleaning pods are deployed to ensure that the pipe interiors remain free from debris and blockages, which could significantly impact system performance. In one or more embodiments, the cleaning pod may include a dust/broom vacuum system and/or a liquid pump. These systems are equipped on robots to handle the regular removal of dust, dirt, and other particulate matter. By maintaining a clean pipe environment, these pods prevent the accumulation of debris that could lead to operational inefficiencies or mechanical wear. The liquid pump may be utilized for more critical cleaning tasks such as dealing with water and other liquids inside the pipes. They feature mechanisms that allow them to attach a hose to external pumping systems. This setup enables the efficient extraction of accumulated liquids, particularly in low-lying sections of the pipe network where water may collect and pose a risk to structural integrity and operation.

### Pod Maintenance/Repair

In one or more embodiments of the invention, the logistics server includes functionality to categorize failures into two primary modes, each corresponding to specific response protocols. The logistics server is configured to detect and diagnose failures remotely, leveraging a network of sensors and communication tools integrated within each pod and throughout the network infrastructure. In one embodiment, when a failure is detected, the affected pod automatically switches to passive mode, reducing any further stress on mechanical components and preventing potential exacerbation of the damage.

Failures classified under the wheel intact category include scenarios where the pod's mobility components such as wheels are not physically damaged but the pod cannot proceed due to other operational failures. These failures could be a motor breakdown, battery depletion, or loss of network connectivity. In one embodiment of the invention, when such a failure is detected, the logistics server is notified immediately via an automated system integrated within the pod. This system uses diagnostic data collected from the pod's sensors to ascertain the cause and specifics of the failure. Once in passive mode, the pod's position and status are monitored while it awaits intervention. Depending on the nature of the failure, the system either schedules a maintenance pod dispatch from the nearest terminal or if feasible, sends instructions for onboard repair mechanisms to attempt a preliminary fix, such as rebooting the system or switching to a backup battery.

A second category of failures is damaged wheel failures, where physical damage to the wheel assembly prevents the pod from continuing its journey. In one or more embodiments, the logistics server may send a specialized repair pod equipped with a remote camera, a robotic arm, and/or a cutting mechanism to intercept the failed pod. This repair pod performs an initial on-site assessment and attempts a repair or stabilization measure to allow the pod to be safely moved or recovered. If the damage is beyond what can be repaired on-site, or if the infrastructure itself is compromised (e.g., a deformed rail or blockage), the system may initiate a more extensive intervention. This could involve digging up the affected infrastructure segment for direct human intervention. The logistics server coordinates these responses, ensuring that all necessary tools and personnel are directed to the correct location swiftly.

### Routing Logic

The routing logic enabling these calculations and adjustments can be implemented in several ways within the system. Some embodiments centralize this logic within the pod itself, allowing for immediate response to local conditions without the need for external commands. This design choice prioritizes rapid decision-making and resilience, ensuring that each pod can navigate effectively even in scenarios of limited communication with the broader network.

In one or more embodiments of the invention, routing logic may be partially implemented within terminal hubs located at key points in the network. These hubs may be configured to act as local traffic managers, analyzing conditions and directing pods as they approach, ensuring smooth flow through critical junctions based on a comprehensive understanding of localized traffic conditions and trends.

### Pod Routing

In one or more embodiments of the invention, the pod's control module is equipped with the capability to autonomously calculate and adjust its route, independently of direct routing instructions from an external source. This functionality allows the pod to determine its path through the network to the intended destination by analyzing an array of data inputs. Different embodiments of the invention can involve implementation of routing logic within the pod, within a terminal controller, and/or within an external logistics server. For example, the control module may be configured to independently determine a path through the network to its destination, based on a set of predefined parameters and real-time data inputs.

In one or more embodiments of the invention, the route calculation process undertaken by the control module involves analysis of multiple factors, including the total distance to the destination, current traffic within the network, potential delays or obstructions along various paths, and/or anticipated changes in network conditions. For example, when tasked with transporting goods from a suburban warehouse to a downtown retail location, the control module evaluates all possible routes. The module assesses each path's length and factors in real-time traffic data to project arrival times. A decision might favor a route that, while not the shortest in distance, circumvents areas prone to congestion, based on historical data and current trends.

In one or more embodiments of the invention, the control module includes functionality to utilize a machine learning model to adjust the pod's route in response to dynamic conditions. The model is configured to analyze historical and real-time network performance data to predict traffic patterns, identify potential bottlenecks, and recommend alternative routes. For example, if a pod encounters a slowdown due to an unforeseen maintenance operation in one of the pipe segments, the machine learning model can predict the impact on adjacent routes and suggest a detour that minimizes additional travel time. This detour might involve routing the pod through a series of lesser-used segments that, according to the model's predictions, will remain clear of significant traffic for the duration of the pod's detour.

In one or more embodiments of the invention, the pod routing system involves embedding passive tags, e.g., RFID tags, within the walls of the pipe segments at regular intervals—for example, every 1-2 feet. Each of these tags contains a unique identifier along with embedded geolocation information, which enables precise location tracking. The tags encode critical routing data such as speed limits for each segment, turn speed limits, and other network-specific rules and parameters. Pods may be configured to adhere to prescribed speeds and network guidelines based on the embedded information. For example, each pod within the delivery system may be equipped with an active RFID scanner. In this example, as a pod travels through the pipe network, its scanner continuously reads the information from the RFID tags embedded in the pipe walls. This scanning allows the pod to know its exact location within the network at any given time.

In one or more embodiments of the invention, each pod also stores a comprehensive map of the network. This map includes not just the physical layout of the network but also dynamic data such as current traffic conditions, maintenance updates, and/or temporary rerouting information. In one embodiment, when a pod pulls into a portal—be it for loading, unloading, maintenance, or other purposes—it connects to the local network interface. This connection allows for the automatic updating of the pod's onboard map and firmware. These updates may include changes in routing algorithms, new RFID tag data, and/or revisions to network traffic rules.

In one or more embodiments of the invention, if a pod needs to reroute due to an obstacle, a blockage, or a change in its delivery schedule, it communicates this change back to the logistics server using its wireless communication capabilities. The server then processes this rerouting information and broadcasts it to other pods that may be affected by the change. This inter-pod communication is facilitated through a network protocol that ensures all pods within the affected area receive the updated routing information in real time.

### Logistics Server Routing

In one or more embodiments of the invention, the logistics server includes a routing engine configured to determine the most efficient paths for pods traveling through the pipe delivery system. This engine employs algorithms that analyze real-time traffic data, pod availability, and the operational status of various pipe segments. The engine integrates data from an array of sensors and input sources within the network to continually assess and manage the flow of pods, ensuring optimal routing based on current conditions.

The routing engine calculates routes by evaluating direct paths between entry and exit portals while also considering alternative paths that may avoid congested areas or bypass sections of the network under maintenance. For example, if a primary route from Portal A to Portal B is typically 5 kilometers but is experiencing heavy traffic that reduces pod speed, the engine might reroute the pod through an alternative 7-kilometer route that, although longer, offers higher travel speeds due to lighter traffic conditions.

This rerouting process involves specific algorithms that calculate travel time based on current speed limits and traffic densities reported by sensors along the routes. If sensors report a congestion that reduces average speed to 10 km/h along the 5-kilometer route, while an alternative 7-kilometer route allows for a consistent speed of 30 km/h, the routing engine will perform a comparative analysis. It computes the expected travel time for both routes—30 minutes for the congested route versus approximately 14 minutes for the alternative route—and selects the faster one.

The server continuously updates the routing decisions as new data becomes available. This dynamic routing capability is supported by a feedback loop where sensor data regarding traffic conditions, pod statuses, and segment health is regularly fed into the routing algorithm, allowing for real-time adjustments to the planned routes. The system logs each routing decision and the data underlying these decisions to refine its algorithms over time, improving accuracy and efficiency.

This detailed tracking and adjustment process ensures that the logistics server can effectively manage the flow of traffic within the pipe delivery system, minimizing delays and optimizing the utilization of network resources. The constant monitoring and adaptive rerouting capabilities of the server play a critical role in maintaining high throughput and delivery reliability in the face of varying network conditions.

### Logistics Server Intelligence

In one or more embodiments of the invention, the logistics server includes functionality to incorporate artificial intelligence to enable dynamic routing of pods based on real-time data inputs. For the logistics server, a machine learning model is utilized to generate dynamic routing decisions. The model is trained using historical data collected from the delivery system, which includes records of past delivery times, route efficiency, pod performance, and incidence of delivery delays. This data is supplemented with simulated scenarios to cover rare but possible situations, such as extreme weather conditions affecting sensor readings or simultaneous failures in multiple pods. The model may incorporate one or more of the following features:

Sensor Data: Speed, location, internal conditions of pods, and proximity alerts.

Beacon/Portal Data: Traffic updates, route segment statuses, and alerts on changes in route conditions.

Shipping/Receiving/Accounting Data: Delivery schedules, priority of deliveries, associated late fees, and cost implications of routing decisions.

In one or more embodiments of the invention, the output of the logistics server's machine learning model is a set of routing instructions for one or more pods in the network. These are detailed as:

Route Changes: Adjustments to current routes represented as a series of waypoints.

Priority Adjustments: Changes in the priority status of deliveries, instructing pods to accelerate or decelerate.

Resource Allocation: Recommendations for resource redistribution, such as rerouting pods to balance the network load.

### Logistics Server Routing Example

In one example, during a peak delivery window, multiple high-priority deliveries are at risk of incurring late fees due to unexpected portal congestion. Sensor data from pods indicates slowing traffic in key segments of the network, and accounting data highlights significant potential late fees for delayed pharmaceutical deliveries. The logistics server aggregates real-time sensor data from pods and portals, along with the shipping commitments and potential financial impacts from the accounting system. The machine learning model processes this data, considering various factors such as the cost-benefit analysis of route changes (weighing potential late fees against additional operational costs). The model determines optimal route adjustments for affected pods, prioritizes deliveries based on cost implications, and issues commands to redistribute some deliveries to less congested routes. Routing instructions are dispatched to individual pods, and priority settings are updated to reflect the urgency of timely delivery for high-stakes shipments. The dynamic routing adjustments allow the system to mitigate the risk of late fees by optimizing the delivery schedule in real-time. The logistics server effectively manages the network load, ensuring that the most critical deliveries are prioritized and less urgent shipments are temporarily slowed to accommodate this shift.

### Pod Intelligence

In one or more embodiments of the invention, one or more pods include functionality to incorporate artificial intelligence to enable dynamic routing of pods based on real-time data inputs. In this case, the pod control module includes functionality to utilize one or more machine learning (ML) models to process various data streams for route calculation. The dynamic routing function utilizes a Reinforcement Learning (RL) model, specifically designed to handle sequential decision-making tasks. This type of model is ideal for environments where actions taken by the system (e.g., route changes) directly influence future data inputs and system states.

In one or more embodiments of the invention, the pod control module's machine learning model is trained using a simulation of the pipe network that includes various scenarios such as congestion, blockages, and variable pod speeds. Training data is generated by simulating the movement of pods through the network under different conditions, collecting sensor data, beacon signals, and logistics server commands. The model learns to associate certain patterns in the input data with optimal routing decisions to improve efficiency (e.g., reduced delivery time, energy conservation).

In one or more embodiments of the invention, the pod control module's machine learning model incorporates features derived from, but not limited to, the following:

Sensor Data: Includes speed, proximity to other pods, and internal conditions (e.g., cargo temperature).

Beacon/Portal Data: Includes traffic density ahead, status of route segments (open or closed), and environmental conditions.

Logistics Server Data: Includes broader network conditions, priority of deliveries, and predictive analytics about future states based on historical data.

In one or more embodiments of the invention, the pod control module's machine learning model outputs recommended actions in the form of route adjustments. These outputs may be formatted as a set of waypoints that define the new path the pod should take. Each waypoint is represented by coordinates within the pipe network and associated instructions (e.g., speed adjustments, stop-and-wait commands).

### Pod Routing Example

In one example, a pod is en route to deliver temperature-sensitive pharmaceuticals. Mid-journey, the logistics server detects a significant slowdown in a section of the network due to maintenance work. Simultaneously, sensors in adjacent pods report increased temperatures in their environment, which could jeopardize the integrity of the pharmaceuticals if experienced by our pod. The pod's control module collects local sensor data (internal temperature, speed, proximity to other pods), beacon signals indicating traffic conditions ahead, and alerts from the logistics server about the slowdown. This data feeds into the machine learning model, which processes the information in real-time. The model evaluates alternative paths, considering factors like total travel time, energy usage, and environmental risks. The model selects an optimal route that avoids the congested area and reduces exposure to higher temperatures. The new route, consisting of a series of waypoints, is sent to the pod's navigation system. The pod adjusts its trajectory according to the new waypoints, changing its speed as instructed to navigate through less crowded segments of the network, effectively bypassing the problem area.

### Services and Applications

In one or more embodiments of the invention, the pipe delivery system is supported by a suite of software applications and services that enable user interaction with the system. These software components are designed to facilitate various functions ranging from administrative management to user engagement and package handling at portals or terminal locations.

### Admin Console

In one or more embodiments of the invention, the pipe delivery system includes a web admin application. The web admin application enables administrators to oversee and manage the operation of the entire network. This interface allows administrators to access real-time data on system performance, including traffic flow, pod status, and/or maintenance schedules. Administrators can also use this interface to configure system settings, authorize user access, and/or manage emergency protocols. In one embodiment, the web admin application includes features for deploying software updates to the pods and portals, adjusting the operational parameters of the pipe network, and generating reports for analysis of system efficiency and usage patterns.

### Delivery Application

In one or more embodiments of the invention, the pipe delivery system includes one or more delivery applications. For example, the system may include a web app and a mobile phone app interface that provide capabilities for tracking and managing shipments by internal and external users. These apps allow users to input and monitor the status of their shipments in real time, receive notifications about expected delivery times, and/or access historical data on past shipments. The apps can be used to submit requests for special handling or expedited shipping, and for external users, to schedule pickups or deliveries at designated portals. These interfaces are designed with secure authentication to ensure that shipment information remains confidential and accessible only to authorized users. In one or more embodiments of the invention, the delivery application includes functionality to provide an unlock code to a user. The user may enter the unlock code at a touch screen of a terminal or portal location in order to trigger the gantry system to receive their package.

### Portal/Terminal User Application

In one or more embodiments of the invention, at portal or terminal locations, the system incorporates user interfaces with touch screen capabilities, enabling direct interaction for package pickup. This interface is typically located near the gantry system that retrieves packages from cache locations. Users can interact with the touch screen to identify themselves, select their shipment, enter an unlock code, and initiate the retrieval process. The interface displays step-by-step instructions for users to follow, ensuring that the package pickup process is clear and efficient. Additionally, the touch screen may provide options for users to provide feedback on their experience or to report issues with their shipment.

### Portal/Terminal Admin Application

In one or more embodiments of the invention, terminal and/or portal locations may include a user interface device operatively connected to an admin application. Accessible via a secure door, the admin interface at the portal or terminal may be configured to provide comprehensive control over the operations conducted at that specific location. This interface may enable system administrators and maintenance personnel to access a wide range of functions, including the calibration of the gantry system, the management of the cache storage system, and the monitoring of security systems at the terminal. In one or more embodiments, the admin application also allows for the adjustment of mechanical components, such as turntables or lift mechanisms, and/or provides diagnostics and alerts on the health of the portal or terminal's hardware and software systems.

### Network Design Tool/Operational Simulator

In one or more embodiments of the invention, the network design tool is a software application engineered to assist system planners and engineers in designing new segments of the logistics network. This tool integrates mapping technologies and algorithms to model the physical and operational constraints of proposed network expansions. It uses geospatial data to map existing infrastructure and to overlay proposed pipe network expansions, allowing planners to visually determine optimal routes and junction placements. The tool also incorporates simulation capabilities that model potential traffic patterns and payload flows through proposed network segments, using historical data and predictive analytics to forecast the load and impact on different parts of the network. Additionally, the tool includes cost estimation features that calculate the financial cost of different design choices, including initial construction costs and long-term maintenance forecasts.

In one or more embodiments of the invention, the operational simulator serves as a testing environment where network administrators can model the performance of the entire logistics system under various scenarios before implementing changes in the real world. The simulator creates a virtual replica of the pipe delivery system, including all physical and operational parameters. This virtual model is used to test the effects of changes to routing algorithms, pod capacities, and scheduling frequencies without impacting actual operations. In one embodiment of the invention, the simulator integrates real-time data feeds from the actual network to update the simulation environment, ensuring that the simulated scenarios are as close to real-life conditions as possible. The tool can simulate peak loads, potential system failures, or emergency conditions, such as simulating the effect of a sudden large-scale influx of orders or a major disruption in a segment of the network.

### Micro-ASRS

In one or more embodiments of the invention, the pipe delivery system includes one or more micro-ASRS (Automated Storage and Retrieval System) containers. Each micro-ASRS container is designed to function effectively within the system, e.g., at the edge of the logistics network, closer to consumers rather than centralized in large logistical hubs. In one or more embodiments, unlike traditional ASRS systems, which typically stores pallets of goods, the micro-ASRS manages individual totes or items more suitable for direct consumer delivery. Thus, it operates similarly to a large vending machine, enhancing the local storage and retrieval efficiency of goods with an emphasis on rapid deployment and flexibility.

In one or more embodiments of the invention, the primary function of the micro-ASRS is to store individual items that the system can then package into various sizes suitable for different delivery methods, such as pipe network pods, drones, or traditional courier services like UPS. In one embodiment, the micro-ASRS is capable of storing removable totes or specific containers, transferring these as whole units as needed. This system takes into account the size, weight, and other characteristics of items, such as fragility and whether they can be stacked, which influences how they are stored and handled.

In one or more embodiments of the invention, the micro-ASRS is comprised of several key components: a robotic arm mounted on a gantry system, which includes a base and track allowing movement across the storage bays; shelves organized into bays, aisles, and lanes with a typical configuration of one SKU per lane, though variations can be organized by item characteristics or size; and an enclosure, often a standard 20-foot shipping container, which provides modularity and the ability to relocate units based on shifting demand. These units may also feature a drive-up window for manual retrieval of items.

In one or more embodiments of the invention, the staging area within the micro-ASRS acts as a buffer zone where items are organized and queued for final assembly and shipment. When an adequate number of orders are prepared, the system's software triggers the robotic arm to package these items into payload bays or containers. This same arm or another within the container can automatically load these packages onto delivery pods, for example.

In one or more embodiments of the invention, each micro-ASRS container is equipped with computing hardware and software designed to manage and optimize its storage and retrieval operations. The core of this system includes a computer processor and memory to handle data analyses and real-time processing demands. Network interfaces enable connectivity options, facilitating communication both within the micro-ASRS network (i.e., with other containers) and with the central logistics server.

In one or more embodiments of the invention, each micro-ASRS features a real-time inventory tracking system, which continuously updates the database with current stock levels and the precise locations of items within the container. This functionality ensures that end users receive accurate and timely information about the availability of goods. Furthermore, the software displays various transportation options available for item delivery, including aerial drones, pod delivery, and ground delivery systems. This allows customers to choose the most suitable delivery method based on their needs and preferences.

In one or more embodiments of the invention, through a connected network system, each unit can communicate with others in the network as well as with the logistics server. This enables coordinating complex order fulfillments that require assembling items from multiple micro-ASRS containers. By leveraging this interconnected system, the micro-ASRS units can efficiently collaborate to compile single orders from dispersed inventory locations, streamlining the logistics process and reducing delivery times.

In one or more embodiments of the invention, the micro-ASRS units are capable of operating with advanced autonomy levels, using AI to fetch items from multiple containers to fulfill orders. They also perform physical defragmentation, consolidating SKUs within or across multiple containers to optimize space and operational efficiency. In various embodiments of the invention, decision-making processes can be handled locally by the intelligent AI within each unit or externally by the logistics server, which views the entire array of containers as a single cohesive system expected to self-optimize. In one or more embodiments, units may feature a drone landing pad on top, broadening the delivery capabilities to include aerial options.

In one or more embodiments of the invention, the integration of micro-ASRS containers with portals at destination terminal locations enables transferring payloads into and out of the pipe network. The micro-ASRS containers may be located at or near destination terminals where they serve as the final aggregation points for goods before/after they are dispatched through the pipe network. Each micro-ASRS is equipped with robotics and conveyor systems that interface directly with the terminal portals. In one or more embodiments, these portals are the entry and exit points for payloads traveling within the pipe network, effectively acting as gateways between the local storage facilities and the broader distribution network.

In one or more embodiments of the invention, payloads stored within the micro-ASRS are automatically sorted and packaged into standardized totes or containers, which are compatible with the specifications of the pods used in the pipe network. In one embodiment, the controller of a micro-ASTS container includes smart scheduling algorithms that coordinate the movements of goods and pods, minimizing wait times and ensuring that payloads are ready for immediate dispatch as soon as pods arrive. Furthermore, in one or more embodiments, RFID tags or QR codes are applied to each container, allowing for automated identification and tracking as items move from the micro-ASRS to the pods and through the pipe network. This tagging system integrates with the logistics server to provide real-time updates on cargo location and status.

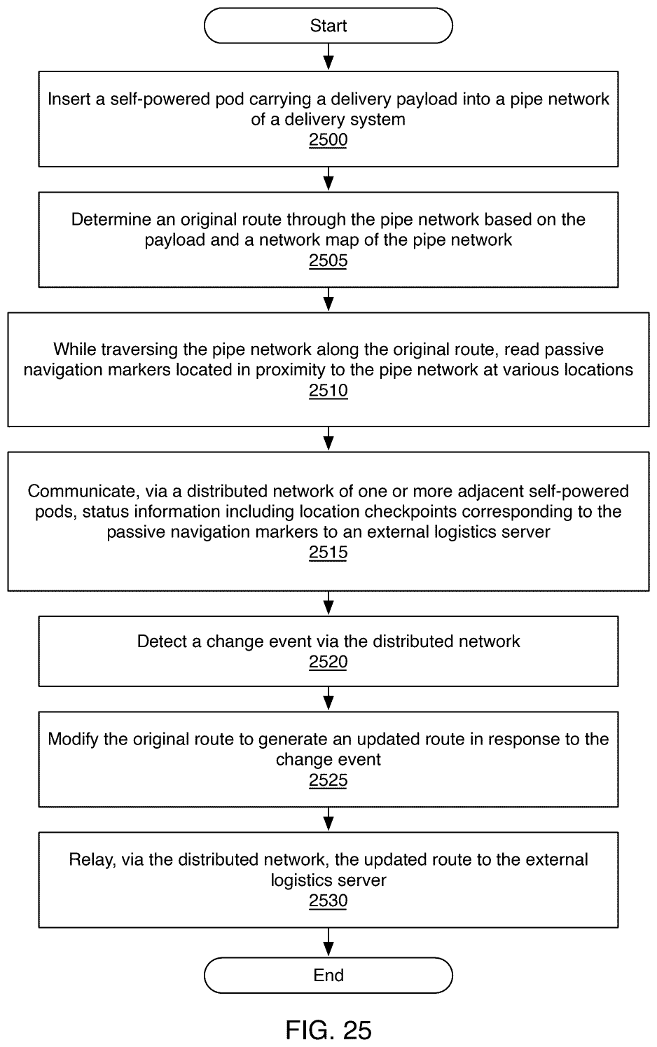

FIG. 25 shows a flowchart of a method for traversing a pipe network with a delivery pod. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 25 should not be construed as limiting the scope of the invention.

In STEP 2500, a self-powered pod carrying a delivery payload is inserted into a pipe network of a delivery system. This involves placing the pod, equipped with the necessary delivery contents (e.g., residing in a removable tote), at an entry point of the pipe network, where it is ready to begin its journey.

In STEP 2505, an original route through the pipe network is determined based on the payload and a network map of the pipe network. This step entails using the payload characteristics and a detailed map of the network to calculate the most efficient path the pod should take to reach its destination.

In STEP 2510, while traversing the pipe network along the original route, passive navigation markers located in proximity to the pipe network at various locations are read. These markers provide essential positional and directional information to assist in the accurate navigation of the pod through the network.

In STEP 2515, status information including location checkpoints corresponding to the passive navigation markers is communicated, via a distributed network of one or more adjacent self-powered pods, to an external logistics server. This communication ensures that the logistics server remains updated on the pod's progress and location within the network.

In STEP 2520, a change event is detected via the distributed network. This may involve encountering unexpected conditions in the network such as blockages, increased traffic, or any other disruptions that could affect the original travel plan.

In STEP 2525, the original route is modified to generate an updated route in response to the change event. This step involves recalculating the travel path taking into account the newly detected conditions to find an alternative route that remains efficient and achievable under the new circumstances.

In STEP 2530, the updated route is relayed, via the distributed network, to the external logistics server. This ensures that all stakeholders, including centralized monitoring systems and potentially other pods, are informed of the change and can adjust their operations accordingly.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

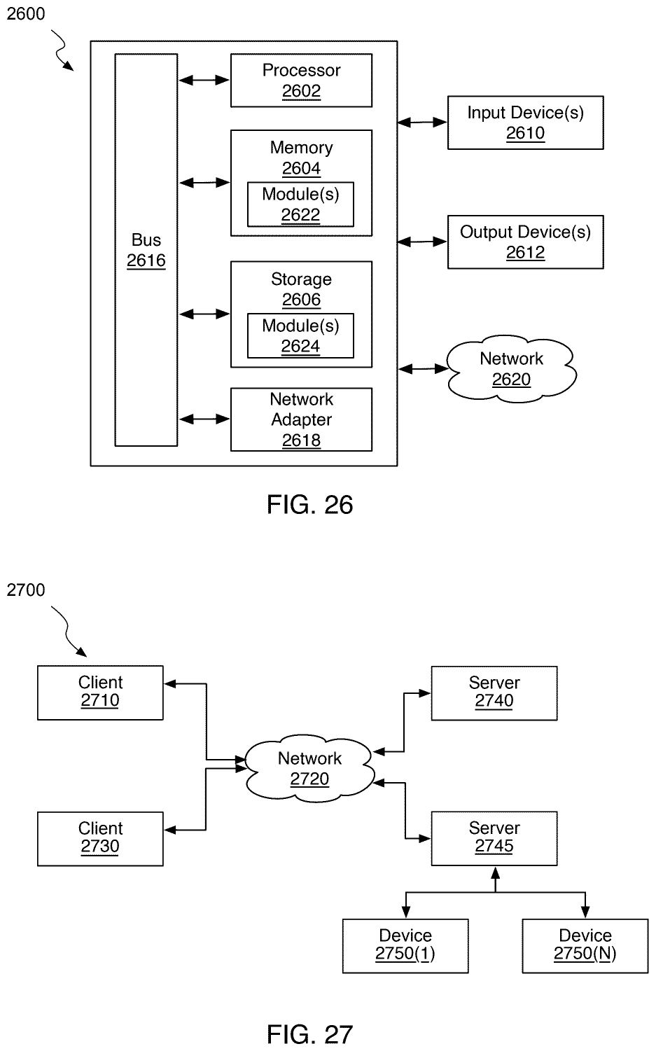

For example, as shown in FIG. 26, the computing system 2600 may include one or more computer processor(s) 2602, associated memory 2604 (e.g., random access memory (RAM), cache memory, flash memory, etc.), one or more storage device(s) 2606 (e.g., a hard disk, an optical drive such as a compact disk (CD) drive or digital versatile disk (DVD) drive, a flash memory stick, etc.), a bus 2616, and numerous other elements and functionalities. The computer processor(s) 2602 may be an integrated circuit for processing instructions. For example, the computer processor(s) may be one or more cores or micro-cores of a processor.

In one or more embodiments, the computer processor(s) 2602 may be an integrated circuit for processing instructions. For example, the computer processor(s) 2602 may be one or more cores or micro-cores of a processor. The computer processor(s) 2602 can implement/execute software modules stored by computing system 2600, such as module(s) 2622 stored in memory 2604 or module(s) 2624 stored in storage 2606. For example, one or more of the modules described herein can be stored in memory 2604 or storage 2606, where they can be accessed and processed by the computer processor 2602. In one or more embodiments, the computer processor(s) 2602 can be a special-purpose processor where software instructions are incorporated into the actual processor design.

The computing system 2600 may also include one or more input device(s) 2610, such as a touchscreen, keyboard, mouse, microphone, touchpad, electronic pen, or any other type of input device. Further, the computing system 2600 may include one or more output device(s) 2612, such as a screen (e.g., a liquid crystal display (LCD), a plasma display, touchscreen, or other display device), a printer, external storage, or any other output device. The computing system 2600 may be connected to a network 2620 (e.g., a local area network (LAN), a wide area network (WAN) such as the Internet, mobile network, or any other type of network) via a network interface connection 2618. The input and output device(s) may be locally or remotely connected (e.g., via the network 2620) to the computer processor(s) 2602, memory 2604, and storage device(s) 2606.

One or more elements of the aforementioned computing system 2600 may be located at a remote location and connected to the other elements over a network 2620. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

FIG. 27 is a block diagram of an example of a network architecture 2700 in which client systems 2710 and 2730, and servers 2740 and 2745, may be coupled to a network 2720. Network 2720 may be the same as or similar to network 2620. Client systems 2710 and 2730 generally represent any type or form of computing device or system, such as client devices (e.g., portable computers, smart phones, tablets, smart TVs, etc.).

Similarly, servers 2740 and 2745 generally represent computing devices or systems, such as application servers or database servers, configured to provide various database services and/or run certain software applications. Network 2720 generally represents any telecommunication or computer network including, for example, an intranet, a wide area network (WAN), a local area network (LAN), a personal area network (PAN), or the Internet.

With reference to computing system 2600 of FIG. 26, a communication interface, such as network adapter 2618, may be used to provide connectivity between each client system 2710 and 2730, and network 2720. Client systems 2710 and 2730 may be able to access information on server 2740 or 2745 using, for example, a Web browser, thin client application, or other client software. Such software may allow client systems 2710 and 2730 to access data hosted by server 2740, server 2745, or storage devices 2750(1)-(N). Although FIG. 27 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 2740, server 2745, storage devices 2750(1)-(N), or any combination thereof. All or a portion of one or more of the example embodiments disclosed herein may also be encoded as a computer program, stored in server 2740, run by server 2745, and distributed to client systems 2710 and 2730 over network 2720.

Although components of one or more systems disclosed herein may be depicted as being directly communicatively coupled to one another, this is not necessarily the case. For example, one or more of the components may be communicatively coupled via a distributed computing system, a cloud computing system, or a networked computer system communicating via the Internet.

And although only one computer system may be depicted herein, it should be appreciated that this one computer system may represent many computer systems, arranged in a central or distributed fashion. For example, such computer systems may be organized as a central cloud and/or may be distributed geographically or logically to edges of a system such as a content/data delivery network or other arrangement. It is understood that virtually any number of intermediary networking devices, such as switches, routers, servers, etc., may be used to facilitate communication.

While the invention has been described with respect to a limited number of embodiments, those skilled in the art, having benefit of this disclosure, will appreciate that other embodiments may be devised that do not depart from the scope of the invention as disclosed herein.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

What is claimed is:

1. A delivery system, comprising:
a commodity-based pipe network configured to provide a transit for delivery pods;
a portal configured to enable insertion and removal of removable totes from pods, the portal comprising a wireless navigation beacon configured to provide navigation data to pods as they traverse the pipe network within proximity of the portal;
an active pod comprising:
a cargo module comprising a removable tote comprising a first payload;
a wireless communication module configured to obtain a set of navigation data from the wireless navigation beacon as the active pod approaches a location of the portal, wherein the set of navigation data comprises an identifier that may be utilized to identify the portal;
a control module configured to: (i) record the set of navigation data along with a timestamp indicating a traversal time, and (ii) dynamically update an intended route through the pipe network based on the set of navigation data to generate a modified route.

2. The system of claim 1, further comprising:
a passive pod without a drive module, comprising:
a second cargo module comprising a second removable tote comprising a second payload;
a passive pod marker;
wherein the wireless communication module of the active pod is further configured to wirelessly scan the passive pod marker of the passive pod, and
wherein the control module is further configured to:
identify an intended destination of the second payload; and
engage a latch for connecting the active pod to the passive pod, wherein the active pod propels the passive pod to a portal location corresponding to the intended destination of the second payload.

3. The system of claim 1, wherein the wireless communication module is configured to receive coordinates, instructions, and environment information at various points within the pipe network, and wherein the various points correspond to both passive and active communication devices embedded within the pipe network.

4. The system of claim 3, wherein the control module is further configured to utilize the wireless communication module to:
communicate location information and instructions to and from adjacent pods using a decentralized messaging protocol, wherein the location information and instructions are routed to a centralized logistics server through a two-way communication device installed at a second portal of the pipe network.

5. The system of claim 1, wherein the control module is further configured to:
obtain an intended destination for the first payload;
calculate the intended route through the pipe network based on the intended destination; and
receive a plurality of environmental data items during traversal of the pipe segment, wherein the plurality of environmental data items comprises information from an adjacent pod, and wherein dynamically updating the intended route through the pipe network during traversal of the pipe segment is further based on the plurality of environmental data items.

6. The system of claim 1, wherein the active pod further comprises:
a storage drive configured to store a network map of the pipe network; and
wherein the control module is further configured to:
receive an updated network map from a two-way communication device installed at the portal; and
download a firmware update from the two-way communication device.

7. The system of claim 1, wherein the control module further comprises functionality to:
determine that a change event will impact the intended route, wherein generating the modified route is based at least partly on the change event; and
transmit, via an adjacent pod within the pipe network, the modified route for eventual delivery to a logistics server using a decentralized messaging protocol.

8. The system of claim 1, wherein the change event is at least one selected from a group consisting of: (1) a service outage, (ii) a product return, and (iii) a local equipment failure.

9. The system of claim 1, wherein the set of navigation data comprises a speed limit corresponding to a segment of the pipe network and a turn speed limit corresponding to a curved segment of the pipe network.

10. The system of claim 1, wherein the pipe network comprises a set of radio frequency identification (RFID) tags affixed to pipe walls of the pipe network, wherein the wireless communication module comprises an RFID reader configured to read passive data from the set of RFID tags, and wherein the control module is further configured to:
record the passive data comprising a timestamp and an identifier of each of the set of RFID tags as the active pod traverses the pipe network;
transmit the passive data to a remote service to enable tracking of the first payload through the pipe network.

11. A delivery system, comprising:
a commodity-based pipe network configured to provide a transit for delivery pods;
a distributed network of pods configured to deliver a plurality of payloads to and from one or more portal locations of the pipe network; and
a logistics server configured to:
send departure and destination locations for each of the plurality of payloads to a portal hub application at a portal location of each payload; and
receive route status information for each of the plurality of payloads from the distributed network of pods;
communicate one or more change events to the distributed network of pods, wherein each of the distributed network of pods is configured to independently self-correct in response to the change event and, after self-correcting, transmit updated route information for the logistics server.

12. The system of claim 11, wherein each of the plurality of pods comprises:
a wireless communication module configured to receive coordinates, instructions, and environment information at various points within the pipe network, and wherein the various points correspond to both passive and active communication devices embedded within the pipe network.

13. The system of claim 11, wherein the logistics server comprises an application programming interface (API) for providing tracking information, the API configured to:
receive a request for tracking a shipment;
identify a first payload of the plurality of payloads carrying the shipment;
query a location tracking repository for information associated with the first payload;
receive, in response to the query, a set of location checkpoints corresponding to the first payload, wherein each of the set of location checkpoints corresponds to a traversal of a first pod of the plurality of pods past a checkpoint location while carrying the first payload along the pipe network; and
provide the set of location checkpoints in response to the request for tracking the shipment.

14. The system of claim 13, wherein the logistics server is further configured to:
calculate an estimated arrival date of the shipment based on the set of location checkpoints.

15. The system of claim 14, wherein the logistics server is further configured to:
perform a real-time distributed location query of the pipe network, wherein the location query comprises an identifier of the first pod;
receive, in response to the location query, a distributed set of responses from a subset of the plurality of pods, each comprising one or more additional location checkpoints traversed by the first pod; and
updating the estimated arrival date based on the one or more additional location checkpoints.

16. A method for delivery, comprising:
inserting a self-powered pod comprising a delivery payload into a pipe network of a delivery system;
determining an original route through the pipe network based on the payload and a network map of the pipe network;
while traversing the pipe network along the original route, reading a plurality of passive navigation markers located in proximity to the pipe network at various locations;
communicating, via a distributed network of one or more adjacent self-powered pods, status information comprising location checkpoints corresponding to the plurality of passive navigation markers to an external logistics server;
detecting a change event via the distributed network;
modifying the original route to generate an updated route in response to the change event; and
relaying, via the distributed network, the updated route to the external logistics server.

17. The method of claim 16, further comprising:
exiting the pod from pipe network at a portal location corresponding to the updated route;
traversing the pod across an exit rail assembly operably connected to the pipe network at the portal location;
offloading a removable tote comprising the payload from the pod and receiving a second removable tote comprising a second payload by the pod;
re-entering the pod into the pipe network with the second payload.

18. The method of claim 16, further comprising:
approaching the pod towards a pipe junction along the updated route, wherein the pod slows as the pod approaches the pipe junction;
activating an electromagnetic switch that triggers a mechanical switch corresponding to a fork at the pipe junction; and
traversing the pod through the fork of the pipe junction.

19. The method of claim 16, further comprising:
determining that the pod requires additional charging in order to complete the updated route;
establishing an electrical connection between the pod and a first adjacent pod; and
charging the pod using a power supply of the first adjacent pod while both the pod and the first adjacent pod are in motion.

20. The method of claim 16, further comprising:
detecting a local mechanical failure of the pod;
transmitting an emergency request for assistance to adjacent pods within range of a local proximity network of the pod;
engaging a passive traversal mode of the pod; and
establishing a tow connection between a first adjacent pod of the adjacent pods with the pod, wherein the first adjacent pod is configured to tow the pod to a maintenance enabled portal location along a route of the first adjacent pod.
